(19) United States
(12) Patent Application Publication
(10) Pub. No.: US 2026/0231011 A1
(43) Pub. Date: Aug. 6, 2026

(54) NETWORK SLICE/SERVICE TYPE FOR POSITIONING AND SENSING

(71) Applicant: QUALCOMM Incorporated, San Diego, CA (US)

(72) Inventors: Alexandros MANOLAKOS, Athens (GR); Mukesh KUMAR, Hyderabad (IN); Srinivas YERRAMALLI, San Diego, CA (US)

(21) Appl. No.: 19/150,874

(22) PCT Filed: Jan. 25, 2024
(86) PCT No.: PCT/US2024/012998

§ 371 Date: Jul. 24, 2025

(30) Foreign Application Priority Data
Mar. 22, 2023 (GR) 20230100238

(51) Int. Cl. H04W 48/18; H04L 41/16; H04W 64/00; H04W 76/19; H04W 76/20; H04W 92/18

(52) U.S. Cl. CPC H04W 48/18; H04L 41/16; H04W 64/00; H04W 76/19; H04W 76/20; H04W 92/18

(57) ABSTRACT

Aspects presented herein may improve the accuracy, latency, and/or reliability of UE positioning by enabling dedicated network slices to be defined and configured for UE positioning and sensing. In one aspect, a UE transmits, for a network entity, a first indication of a list of NSSAI, where each NSSAI in the list of NSSAI is associated with at least one of a positioning mode, a sensing mode, a positioning-specific service type, or a sensing-specific service type. The UE communicates with the network entity based on at least one of the positioning mode, the sensing mode, the positioning-specific service type, or the sensing-specific service type. In some examples, the NSSAI may include at least one of: high-accuracy NSSAI, low-latency NSSAI, low-power NSSAI, SL positioning NSSAI, hybrid Uu-SL positioning NSSAI, or ML-enabled positioning NSSAI.

### CROSS-REFERENCE TO RELATED APPLICATION

This application claims the benefit of Greece application No. 20230100238, entitled “NETWORK SLICE/SERVICE TYPE FOR POSITIONING AND SENDING” and filed on Mar. 22, 2023, which is expressly incorporated by reference herein in its entirety.

### TECHNICAL FIELD

The present disclosure relates generally to communication systems, and more particularly, to a wireless communication involving positioning and network slicing.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus transmits, for a network entity, a first indication of a list of network slice selection assistance information (NSSAI), where each NSSAI in the list of NSSAI is associated with at least one of a positioning mode, a sensing mode, a positioning-specific service type, or a sensing-specific service type. The apparatus communicates with the network entity based on at least one of the positioning mode, the sensing mode, the positioning-specific service type, or the sensing-specific service type.

In an aspect of the disclosure, a method, a computer-readable medium, and an apparatus are provided. The apparatus receives, from a user equipment (UE), a first indication of a list of NSSAI, where each NSSAI in the list of NSSAI is associated with at least one of a positioning mode, a sensing mode, a positioning-specific service type, or a sensing-specific service type. The apparatus communicates with the UE based on at least one of the positioning mode, the sensing mode, the positioning-specific service type, or the sensing-specific service type.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example downlink (DL) positioning reference signal (PRS) resource prioritization in accordance with various aspects of the present disclosure.

FIG. 6 is a diagram illustrating an example format of a single network slice selection assistance information (S-NSSAI) in accordance with various aspects of the present disclosure.

FIG. 7A is a diagram illustrating an example network slice selection in a 4G Long Term Evolution (LTE) network in accordance with various aspects of the present disclosure.

FIG. 7B is a diagram illustrating an example network slice selection in a 5G New Radio (NR) network in accordance with various aspects of the present disclosure.

FIG. 8 is a diagram illustrating an example of managing and identifying network slices by UE route selection policy (URSP) and S-NSSAIs in accordance with various aspects of the present disclosure.

FIG. 9 is a communication flow illustrating an example of a network entity configuring network slice(s) associated with positioning/sensing for a UE in accordance with various aspects of the present disclosure.

FIG. 10 is a flowchart of a method of wireless communication.

FIG. 11 is a flowchart of a method of wireless communication.

FIG. 12 is a diagram illustrating an example of a hardware implementation for an example apparatus and/or network entity.

FIG. 13 is a flowchart of a method of wireless communication.

FIG. 14 is a flowchart of a method of wireless communication.

FIG. 15 is a diagram illustrating an example of a hardware implementation for an example network entity.

### DETAILED DESCRIPTION

Aspects presented herein may improve the accuracy, latency, and/or reliability of UE positioning by enabling dedicated network slice(s) to be defined and configured for UE positioning and/or sensing (e.g., radio frequency (RF) sensing). In one aspect of the present disclosure, positioning/sensing specific network slices and slice differentiators (SDs) may be defined/configured for positioning/sensing entities (e.g., a UE, one or more base stations, a location server, etc.). For example, one or more standard slice/service type (SST) values may be introduced/configured for positioning/sensing related services. If more than one SST value is introduced/configured, the SST value(s) may map (e.g., implicitly) to one or more positioning/sensing modes, where the one or more positioning modes may be associated with a high accuracy positioning/sensing slice, a low latency positioning/sensing slice, a low power positioning/sensing slice, an ML-enabled positioning/sensing slice, and/or a Uu/SL-hybrid positioning slice, etc. The positioning/sensing specific network slices and SDs may also be configured to support non-standardized SST values for differentiating positioning services, and/or for supporting SD signaling for various positioning modes.

Based on the network slicing described herein, businesses with multiple applications may allocate different latency or bandwidth capabilities to specific systems that have a greater capacity specification, such as Internet-of-Things (IoT)-enabled smart meters. A single network may be used to offer various services based on the specifications/demands of the user and various use cases. Network operators may also be able to allocate the suitable/right number of specified resources as per network slice. Hence, aspects presented herein may provide a more effective and efficient utilization of resources. For example, one network slice may be designed/configured to deliver low latency and low data rate while another network slice may be designed/configured to deliver a high throughput, etc. Aspects presented herein may also enable network operators to reduce operating expenses (OPEX) and capital expenditure (CAPEX). Aspects presented herein also vastly improve operational efficiency and time to market for the delivery of network services.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

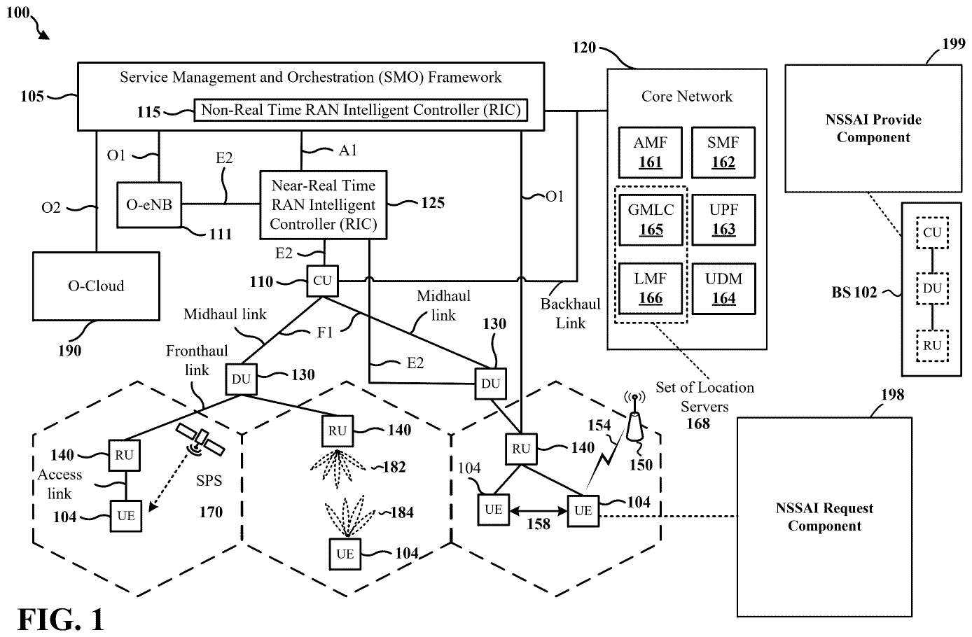

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a network slice selection assistance information (NSSAI) request component 198 that may be configured to transmit, for a network entity, a first indication of a list of NSSAI, where each NSSAI in the list of NSSAI is associated with at least one of a positioning mode, a sensing mode, a positioning-specific service type, or a sensing-specific service type; and communicate with the network entity based on at least one of the positioning mode, the sensing mode, the positioning-specific service type, or the sensing-specific service type.

In certain aspects, the base station 102 may have an NSSAI provide component 199 that may be configured to receive, from a UE, a first indication of a list of NSSAI, where each NSSAI in the list of NSSAI is associated with at least one of a positioning mode, a sensing mode, a positioning-specific service type, or a sensing-specific service type; and communicate with the UE based on at least one of the positioning mode, the sensing mode, the positioning-specific service type, or the sensing-specific service type.

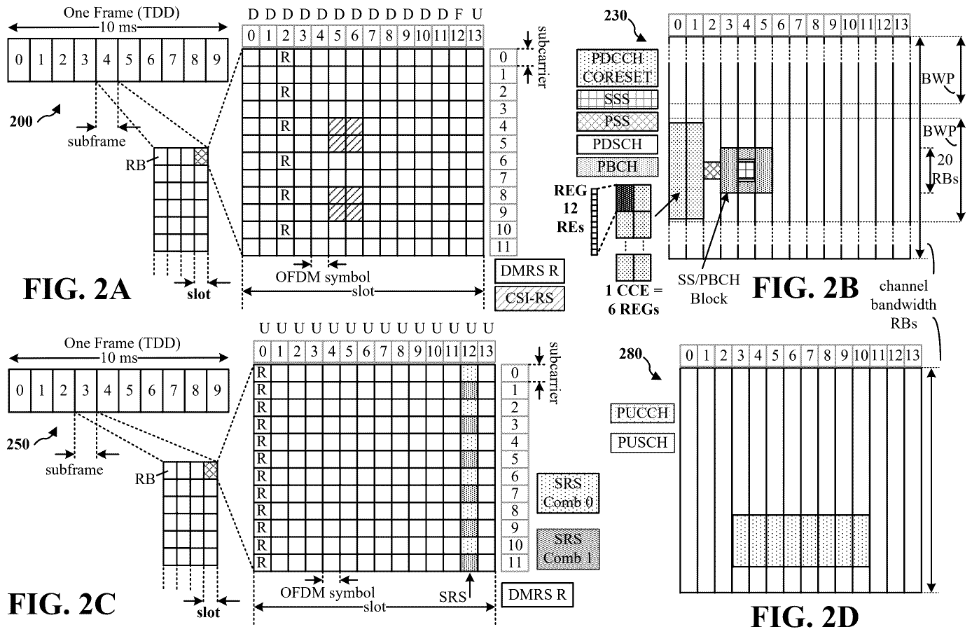

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

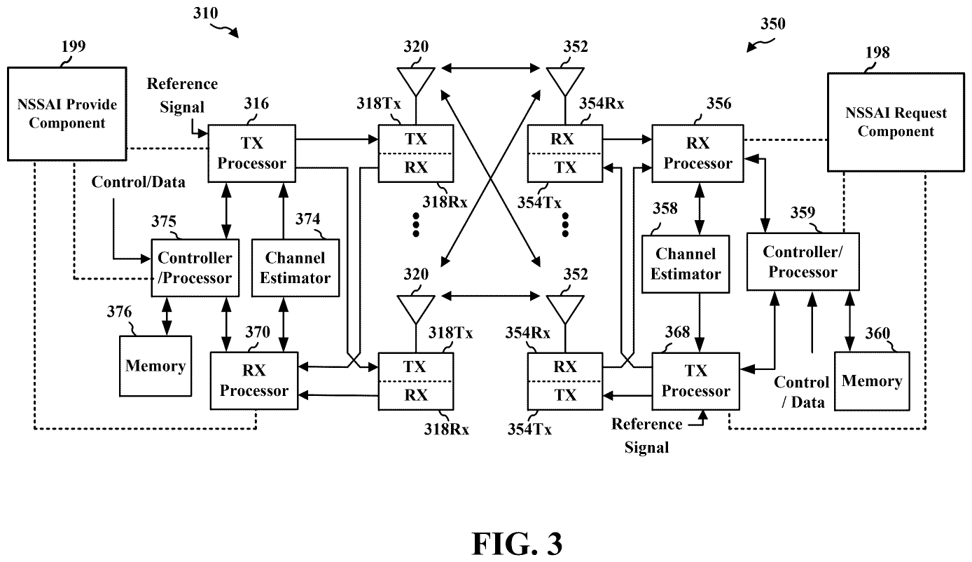

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency-domain, and then combined together using an Inverse Fast Fourier Transform (IFFT) to produce a physical channel carrying a time-domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency-domain using a Fast Fourier Transform (FFT). The frequency-domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the NSSAI request component 198 of FIG. 1.

At least one of the TX processor 316, the RX processor 370, and the controller/processor 375 may be configured to perform aspects in connection with the NSSAI provide component 199 of FIG. 1.

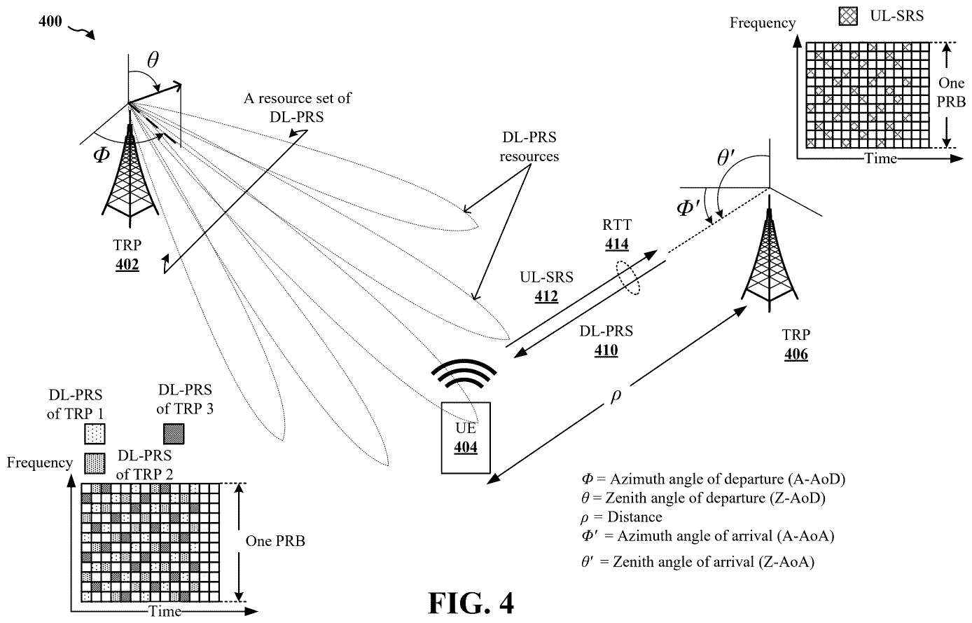

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_TX} and receive DL positioning reference signals (PRS) (DL PRS) 410 at time T_{PRS_RX}. The TRP 406 may receive the UL SRS 412 at time T_{SRS_RX} and transmit the DL PRS 410 at time T_{PRS_TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.”

In addition to network-based UE positioning technologies, a wireless device (e.g., a base station/TRP, a UE, etc.) may also be configured to include radar capabilities, which may be referred to as “radio frequency (RF) sensing,” “cellular-based RF sensing,” and/or simply “sensing.” For example, a wireless device may transmit radar reference signals (RRSs) and measure the RRSs reflected from one or more objects. Based at least in part on the measurement, the wireless device may determine or estimate a distance between the wireless device and the one or more objects. In another example, a first wireless device may also receive RRSs transmitted from one or more wireless devices, where the first wireless device may determine or estimate a distance between the first wireless device and one or more wireless devices based at least in part on the received RRS. As such, in some examples, RF sensing techniques may be used for UE positioning and/or for assisting UE positioning. For purposes of the present disclosure, a device that is capable of performing RF sensing (e.g., transmitting and/or receiving RRS for detecting an object) may be referred to as an “RF sensing node.” For example, an RF sensing node may be a UE, a base station, a TRP, a device capable of transmitting RRS, and/or a device configured to perform radar functions, etc.

A positioning frequency layer (PFL) (or a “frequency layer” in some examples) may refer to a collection of one or more PRS resource sets across one or more TRPs that have the same values for certain parameters. Specifically, the collection of PRS resource sets may have the same subcarrier spacing and cyclic prefix (CP) type (e.g., meaning all numerologies supported for PDSCHs are also supported for PRS), the same Point A, the same value of the downlink PRS bandwidth, the same start PRB (and center frequency), and/or the same comb-size, etc. The Point A parameter may take the value of a parameter ARFCN-ValueNR (where “ARFCN” stands for “absolute radio-frequency channel number”) and may be an identifier/code that specifies a pair of physical radio channel used for transmission and reception. In some examples, a downlink PRS bandwidth may have a granularity of four PRBs, with a minimum of 24 PRBs and a maximum of 272 PRBs. In other examples, up to four frequency layers may be configured, and up to two PRS resource sets may be configured per TRP per frequency layer.

The concept of a frequency layer may be similar to a component carrier (CC) and a BWP, where CCs and BWPs may be used by one base station (or a macro cell base station and a small cell base station) to transmit data channels, while frequency layers may be used by multiple (e.g., three or more) base stations to transmit PRS. A UE may indicate the number of frequency layers it is capable of supporting when the UE sends the network its positioning capabilities, such as during a positioning protocol session. For example, a UE may indicate whether it is capable of supporting one or four PFLs.

In some scenarios, a UE may receive a plurality of PRS resources from multiple TRPs via one or more PFLs, where the UE may not have capabilities to process all of the plurality of PRS resources. As such, the UE may apply a predefined prioritization rule to prioritize measurements of PRS resources. Based on the predefined prioritization rule, the UE may measure a subset of the plurality of PRS resources, and the UE may skip measuring another subset of the plurality of PRS resources.

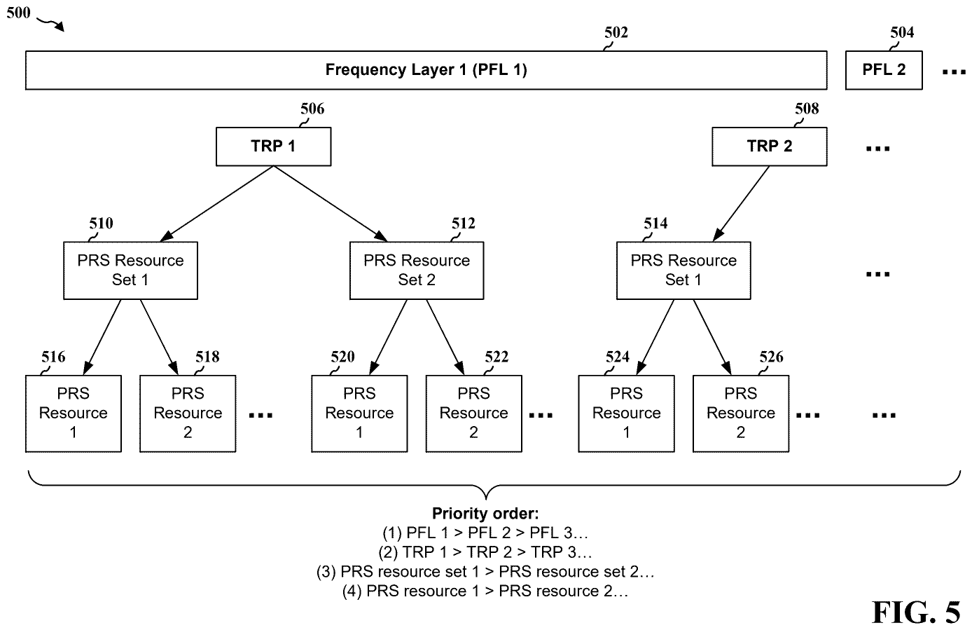

FIG. 5 is a diagram 500 illustrating an example DL PRS resource prioritization in accordance with various aspects of the present disclosure. A UE may be configured with a number of PRS resources in an assistance data of a positioning session, where the number of PRSs resources to be process by the UE may be beyond the processing capability of the UE. In one example, the UE may assume the DL PRS resources in the assistance data are sorted in a decreasing order of measurement priority. For example, if the UE is configured to receive or measure the DL PRS resources via multiple frequency layers (e.g., PFLs), where each PFL may include PRS resources transmitted from multiple TRPs in, the UE may measure the DL PRS resources based on the priority associated with the multiple frequency layers (e.g., from a first frequency layer to a last frequency layer), based on the priority associated with the TRPs in each PFL (e.g., from a first TRP to a last TRP in a PFL), based on the priority associated with the RPS resource sets associated with each TRP (e.g., from a first PRS resource set to a last PRS resource set in a TRP), and based on the priority associated with the RPS resources within each PRS resource set (e.g., from a first PRS resource to a last PRS resource in a resource set), etc.

For example, as shown by the diagram 500, the UE may be configured to receive DL PRSs from a first frequency layer 502 (PFL 1) and a second frequency layer 504 (PFL 2). The first frequency layer 502 may include DL PRSs transmitted from a first TRP 506 and a second TRP 508, where the first TRP 506 may transmit PRSs using a first PRS resource 516 and a second PRS resource 518 in a first PRS resource set 510, and using a first PRS resource 520 and a second PRS resource 522 in a second PRS resource set 512, and the second TRP 508 may transmit PRSs using a first PRS resource 524 and a second PRS resource 526 in a first PRS resource set 514. Similarly, the UE may also receive DL PRSs from the second frequency layer 504 via multiple TRPs, PRS resource sets, and/or PRS resources.

In one example, if the UE does not have the capability to process all the configured PRS resources, the UE may be configured to receive or measure the PRSs received from the first frequency layer 502 first before processing PRSs in the second frequency layer 504. Similarly, if there are also a third frequency layer (PFL 3) and a fourth frequency layer (PFL 4), the UE may be configured to receive or measure the PRSs received from the first frequency layer 502 first, then the PRSs received from the second frequency layer 504, then the PRSs received from the third frequency layer, and then the PRSs received from the fourth frequency layer (e.g., PRSs are processed/measured based on PFL 1>PFL 2>PFL 3>PFL 4). If the UE does not have the capability to process/measure PRSs in a frequency layer, the UE may skip measuring the PRSs in that frequency layer. For example, if the UE is configured to receive the PRSs via the first frequency layer 502 and the second frequency layer 504 but the UE is just able to process/measure PRSs in the first frequency layer 502, the UE may skip PRS measurements for the second frequency layer 504.

Similarly, within a frequency layer, if the UE does not have the capability to process all the PRSs in the frequency layer, the UE may prioritize its PRS measurements based on the priorities associated with the TRPs. For example, the UE may be configured to receive or measure the PRSs received from the first TRP 506 before processing PRSs from the second TRP 508. Similarly, if there are also a third TRP (TRP 3) and a fourth TRP (TRP 4), the UE may be configured to receive or measure the PRSs received from the first TRP 506, then receive or measure the PRSs from the second TRP 508, then receive or measure the PRSs from the third TRP, and then receive or measure the PRSs from the fourth TRP (e.g., PRSs are processed/measured based on TRP 1>TRP 2>TRP 3>TRP 4 with a frequency layer). If the UE does not have the capability to process/measure PRSs from a TRP, the UE may skip measuring the PRSs in that TRP. For example, if the UE is configured to receive the PRSs via the first TRP 506 and the second TRP 508 via the first frequency layer 502 but the UE is just able to process/measure PRSs in the first TRP 506, the UE may skip PRS measurements for the second TRP 508.

Furthermore, within a TRP, if the UE does not have the capability to process all the PRSs in that TRP, the UE may prioritize its PRS measurements based on the priorities associated with the PRS resource sets. For example, the UE may be configured to receive or measure the PRSs received from the first PRS resource set 510 first before processing PRSs from the second PRS resource set 512. Similarly, if there are also a third PRS resource set (PRS resource set 3) and a fourth PRS resource set (PRS resource set 4), the UE may be configured to receive or measure the PRSs received from the first PRS resource set 510 first, then the PRSs received from the second PRS resource set 512, then the PRSs received from the third PRS resource set, and then the PRSs received from the fourth PRS resource set (e.g., PRSs are processed/measured based on PRS resource set 1>PRS resource set 2>PRS resource set 3>PRS resource set 4 with a TRP). If the UE does not have the capability to process/measure PRSs in a PRS resource set, the UE may skip measuring the PRSs in that PRS resource set. For example, if the UE is configured to receive the PRSs via the first PRS resource set 510 and the second PRS resource set 512 from the first TRP 506 but the UE is just able to process/measure PRSs in the first PRS resource set 510, the UE may skip PRS measurements for the second PRS resource set 512.

Lastly, within a PRS resource set, if the UE does not have the capability to process all the PRSs in that PRS resource set, the UE may prioritize its PRS measurements based on the priorities associated with the PRS resources. For example, the UE may be configured to receive or measure the PRSs received from the first PRS resource 516 first before processing PRSs from the second PRS resource 518. Similarly, if there are also a third PRS resource (PRS resource 3) and a fourth PRS resource (PRS resource 4), the UE may be configured to receive or measure the PRSs received from the first PRS resource 516 first, then the PRSs received from the second PRS resource 518, then the PRSs received from the third PRS resource, and then the PRSs received from the fourth PRS resource (e.g., PRSs are processed/measured based on PRS resource 1>PRS resource 2>PRS resource 3>PRS resource 4 with a PRS resource set). If the UE does not have the capability to process/measure PRSs in a PRS resource, the UE may skip measuring the PRSs in that PRS resource. For example, if the UE is configured to receive the PRSs via the first PRS resource 516 and the second PRS resource 518 of the first PRS resource set 510 but the UE is just able to process/measure PRSs in the first PRS resource 516, the UE may skip PRS measurements for the second PRS resource 518.

As such, if a UE is configured with multiple PRS resources via multiple frequency layers, multiple TRPs, multiple PRS resource sets, and/or multiple PRS resources, the UE may sort the frequency layers (e.g., may be up to four frequency layers) according to a priority, sort the TRPs per frequency layer (e.g., may be up to sixty four (64) TRPs per frequency layer) also according to a priority, sort the PRS resource sets per TRP (e.g., may be up to two resource sets per TRP) according to a priority, and/or sort the PRS resource per PRS resource set (e.g., may be up to sixty four (64) PRS resources per PRS resource set). In other words, within a positioning frequency layer, the DL PRS resources may be sorted in the decreasing order of priority for measurement to be performed by the UE, with the reference indicated by nr-DL-PRS-ReferenceInfo being the highest priority for measurement, and the following priority is assumed: (1) up to 64 dl-PRS-IDs of the frequency layer are sorted according to priority; and (2) up to 2 DL PRS resource sets per dl-PRS-ID of the frequency layer are sorted according to priority.

A network may be configured to create multiple unique logical and/or virtualized networks over a common multi-domain infrastructure based on network slicing. Network slicing allows an operator of a network to provide customized networks. For example, there may be different specifications on functionality (e.g., priority, charging, policy control, security, and/or mobility, etc.), differences in performance specifications (e.g., latency, mobility, availability, reliability and/or data rates, etc.), and/or to serve specific users (e.g., multimedia priority service (MPS) users, public safety users, corporate customers, and/or roamers, etc.). A network slice may provide the functionality of a complete network, including radio access network functions, core network functions (e.g., potentially from different vendors), and/or Internet Protocol (IP) multimedia subsystem (IMS) functions, etc. One network may support one or several network slices.

Network slicing may be considered as one of key features for the 5G NR network and beyond (e.g., future generation networks such as 6G). In some examples, a network slice may be looked as a logical end-to-end network that may be dynamically created. A UE may access multiple slices over the same network entity (e.g., a base station, a gNB, etc.). Each network slice may be configured to serve a particular service type with agreed upon service-level agreement (SLA).

A network slice may be defined within a public land mobile network (PLMN) and include core (e.g., the 5G Core) and radio access network (RAN) (e.g., the 5G RAN) control plane network and user plane network. In some implementations, identification of a network slice may be performed via single network slice selection assistance information (S-NSSAI), where network slice selection assistance information (NSSAI) may refer to a collection of S-NSSAIs. Some networks may allow just a defined number of S-NSSAIs to be included in an NSSAI (e.g., up to eight (8) S-NSSAIs) in signaling messages between a UE and a network. In other words, a single UE may be served by at most the defined number of network slices (e.g., eight network slices) at a time. In some examples, a UE may signal S-NSSAI to a network to assist the network in selecting a particular network slice instance.

For purposes of the present disclosure, a network function may refer to a specific (e.g., 3GPP) adopted or defined processing function in a network, which has defined functional behavior and specific (e.g., 3GPP) defined interfaces. A network function may be implemented either as a network element on a dedicated hardware, as a software instance running on a dedicated hardware, and/or as a virtualized function instantiated on an appropriate platform, e.g., on a cloud infrastructure. A network slice may refer to a logical network that provides specific network capabilities and network characteristics. A network slice instance may refer to a set of network function instances and the specified resources (e.g., compute, storage, and networking resources, etc.) which form a deployed network slice.

In some examples, network slicing may be classified into hard slicing and soft slicing. Under the hard slicing, network slices (which may also be referred to as “hard slicing network slices” or “hard network slicing”) may be specified to be completely isolated from each other, whereas under the soft slicing, network slices (which may also be referred to as “soft slicing network slices” or “soft network slicing”) may share certain network resources.

In terms of network slice identity management, an S-NSSAI may serve as an identifier for a network slice across a core network (e.g., 5GC), a RAN (e.g., 5G-RAN) and at least one UE. The S-NSSAI may be associated with a PLMN (e.g., a PLMN ID) and have network-specific values or standard values. Thus, a UE may use an S-NSSAI to access a network in the PLMN in which the S-NSSAI is associated with. In some implementations, an S-NSSAI may be configured to include a slice/service type (SST) and/or a slice differentiator (SD). An SST may refer to an expected network slice behavior in terms of features and services. An SD may be an (optional) information that complements the SST(s) to differentiate amongst multiple network slices of the same SST. In some examples, an SST (or an SST ID) may be configured to be mandatory with a specific length (e.g., 8 bits). In other words, it may be mandatory for an S-NSSAI to include an SST (or an SST ID). On the other hand, as an SD is used for differentiating network slices with the same SST, it may not be mandatory (e.g., it may be optional) for an S-NSSAI to include an SD. In some examples, an SD may have a total length of 24 bits.

In some examples, an S-NSSAI may be classified into standardized S-NSSAI and non-standard S-NSSAI. The standardized S-NSSAI may include just SST and no SD, whereas the non-standard S-NSSAI may be defined as either SST alone (non-standard) or SST+SD.

Some values for an SST may be standardized and associated with a specific slice/service type and/or characteristics, where these standardized values of SST may be used for addressing different use cases for a network. For example, standardized values of SST may address the three main use cases (e.g., enhanced mobile broadband (eMBB), ultra-reliable low latency communications (URLLC), and massive machine type communications (mMTC)) for the 5G network. As an illustration, if the length of an SST is 8 bits, the SST may provide up to 256 SST values (e.g., 2\hat{ }8=256), where certain SST values (e.g., values 0 to 127) may be reserved for standardized SST. The non-standardized values (e.g., values 128 to 255) may also be used/reserved for the SST. In some examples, non-standardized values may allow an operators of networks to introduce network slice(s) which support their own specific service specifications.

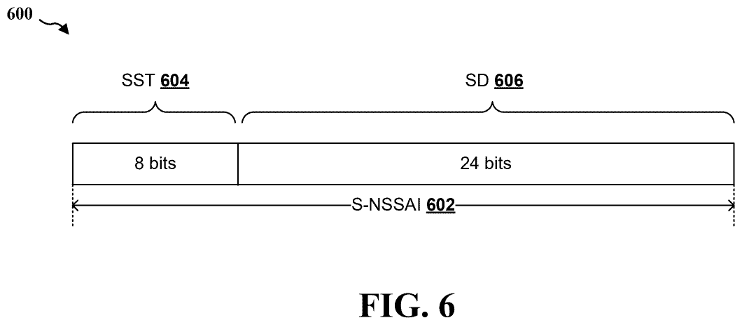

FIG. 6 is a diagram 600 illustrating an example format of an S-NSSAI in accordance with various aspects of the present disclosure. An S-NSSAI 602 may include both an SST field 604 and an SD field 606 (in which case the total length of the S-NSSAI 602 may be 32 bits), or the S-NSSAI may just include the SST field 604 (in which case the total length of the S-NSSAI 602 may be just 8 bits). The SST field 604 may refer to an expected network slice behavior in terms of features and services, and the SD field 606 may provide optional information that complements the slice/service type(s) to differentiate amongst multiple network slices of the same slice/service type. The SST field 604 may have standardized and non-standardized values. For example, values 0 to 127 may belong to the standardized SST range, and values 128 to 255 may belong to an operator-specific range. The SD field 606 may have a reserved value “no SD value associated with the SST” defined as hexadecimal FFFFFF. In certain protocols, the SD field may not be included to indicate that no SD value is associated with the SST.

Table 2 below provides an example of standardized SST values. Standardized SST values may provide a way for establishing global interoperability for slicing so that PLMNs may support the roaming use cases more efficiently for the most commonly used slice/service types.

TABLE 2
Example of Standardized SST Values

| Slice/Service | SST | |
|---|---|---|
| type | value | Characteristics |
| eMBB | 1 | Slice suitable for the handling of 5G enhanced |
| | | Mobile Broadband. |
| URLLC | 2 | Slice suitable for the handling of ultra- reliable low |
| | | latency communications. |
| MIoT | 3 | Slice suitable for the handling of massive IoT. |
| V2X | 4 | Slice suitable for the handling of V2X services. |
| HMTC | 5 | Slice suitable for the handling of High-Performance |
| | | Machine-Type Communications. |

In some implementations, the support of all standardized SST values may not be specified in a PLMN. Services indicated in Table 2 for each SST value may also be supported by means of other SSTs. In some examples, a mapping of Groupe Speciale Mobile Association (GSMA) defined network slice types (NEST) to standard SST values may also be defined in a specification/standard.

Table 3 below provides an example of different types of NSSAIs.

TABLE 3
Example of Different Types of NSSAIs.

| Type of NSSAI | Description |
|---|---|
| Subscribed | It may be stored in a unified data management (UDM) |
| S-NSSAIs | and a core network (e.g., 5GC) may use this as a |
| | default when a UE does not send a Requested NSSAI. |
| Configured | A PLMN may configure a UE with one or more |
| NSSAI | configured NSSAIs, and the UE may use the one or |
| | more configured NSSAIs as its default NSSAI(s). |
| | A configured NSSAI could be the same as the |
| | subscribed S-NSSAIs. Up to sixteen (16) S-NSSAIs |
| | may be included within a configured NSSAI. An |
| | access and mobility management function (AMF) |
| | may use a non-access stratum (NAS) registration |
| | accept message (e.g., NAS: Registration Accept) |
| | message and/or a NAS configuration update |
| | command message (e.g., NAS: Configuration Update |
| | Command) to signal a configured NSSAI to a UE. |
| Allowed | It is a value assigned by a core network (e.g., 5GC), |
| NSSAI | which may be valid in a registration area or the PLMN |
| | over a given access type. |
| | There may be a maximum of eight (8) network slices |
| | within an allowed NSSAI, (i.e., a UE may be served |
| | by a maximum of eight network slices). |
| | Using all eight network slices may specify a UE to |
| | establish eight packet data unit (PDU) sessions. |
| | Similar to the configured NSSAI, an AMF may use a |
| | NAS registration accept message (e.g., NAS: |
| | Registration Accept) message and/or a NAS |
| | configuration update command message (e.g., NAS: |
| | Configuration Update Command) to signal an |
| | allowed NSSAI to a UE. |
| | An allowed NSSAI may also be signaled to a network |
| | entity (e.g., a base station, a gNB, etc.) using a next- |
| | generation application protocol (NGAP) initial |
| | context setup request message (e.g., NGAP Initial |
| | Context Setup Request). The network entity may use |
| | this information when allocating resources for a UE. |
| Requested | It may be a configured NSSAI, an allowed NSSAI, or |
| NSSAI | a combination thereof. |
| | A UE may send a requested NSSAI in both radio |
| | resource control (RRC) setup complete message and |
| | NAS registration request message. |
| | A network entity (e.g., a base station, a gNB, |
| | etc.) may use this for an AMF selection and |
| | provisional handling before getting an allowed |
| | NSSAI. |
| | A core network (e.g., 5GC) may use this for slice |
| | selection, validation etc., and returns an allowed |
| | NSSAI. |
| Rejected | It may be rejected in a registration area (or) for an |
| NSSAI | entire PLMN. A UE may be configured not to attempt |
| | this NSSAI again in that registration area or in the |
| | PLMN. |

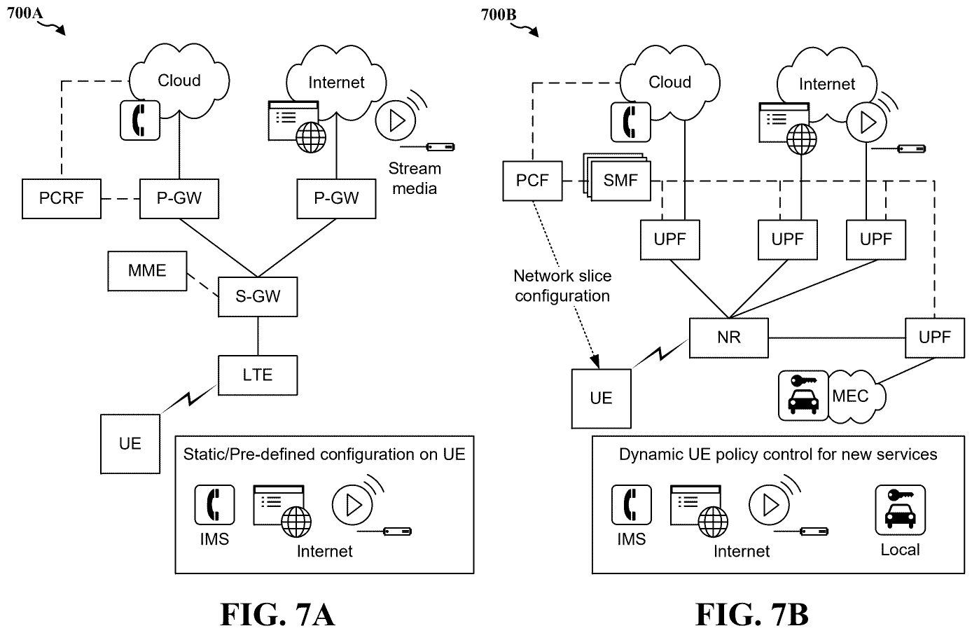

FIG. 7A is a diagram 700A illustrating an example network slice selection in a 4G LTE network in accordance with various aspects of the present disclosure. Under the 4G network systems/architectures, it may be difficult (e.g., nearly impossible) to install new services in the network for a UE.

FIG. 7B is a diagram 700B illustrating an example network slice selection in a 5G NR network in accordance with various aspects of the present disclosure. On the other hand, under the 5G network, the slice selection policy may be configured dynamically through a UE route selection policy (URSP), while slice selection policy may be pre-defined and unable to be changed dynamically in the 4G network. Through the URSP feature, 5G network operators may easily configure new service(s) for a UE. Along with the concept of network slicing and features in the RAN and core network, a URSP may refer to or provide a way to manage network slice information for the UE. A URSP may be a network slice feature enabled by a policy control function (PCF) which informs the network slice status to the UE via the AMF. A URSP may contain operating system identification (OSId), application identification (AppId), and/or Internet protocol (IP) descriptors to define an application and S-NSSAI, data network name (DNN), session and service continuity (SSC) mode information for the application and network slice mapping.

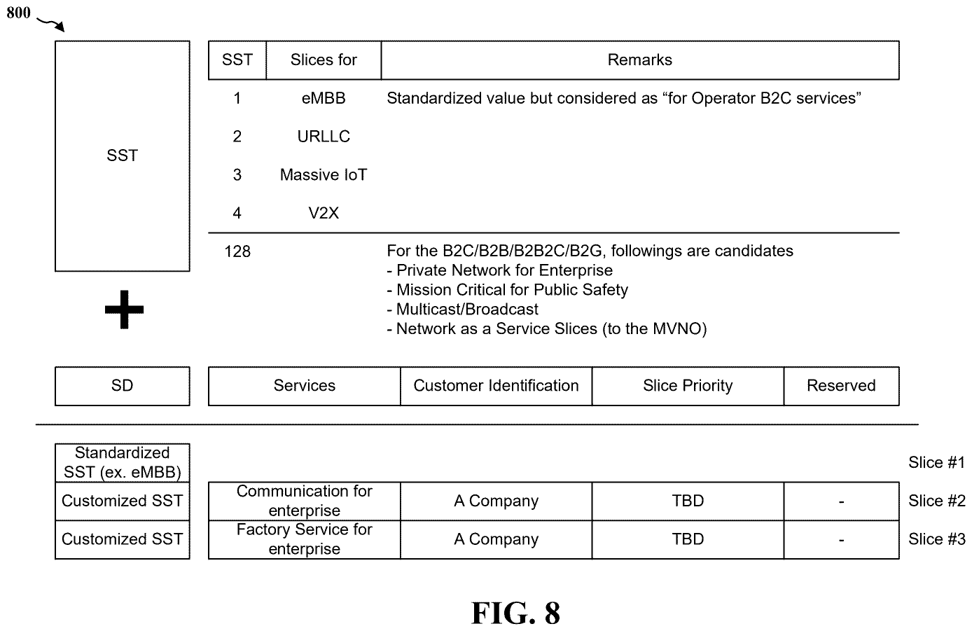

FIG. 8 is a diagram 800 illustrating an example of managing and identifying network slices by URSP and S-NSSAIs in accordance with various aspects of the present disclosure. In some scenarios, a UE may be already aware of some of the standardized S-NSSAI defined in a specification (e.g., signaled to the UE, pre-defined at the UE, etc.) and a network operator may also introduce some of the non-standardized S-NSSAI to achieve any UE specific goal of latency, throughput, and/or power specifications, etc. In one example, standardized S-NSSAI may be defined in a specification, while non standardized S-NSSAI may be delivered/indicated to a UE through RRC/NAS signaling. In some examples, a UE may be specified/configured to provide a list of suitable or desired S-NSSAI value(s) as part of a registration procedure.

As described in connection with FIG. 4, various types of UE positioning mechanisms may be deployed by a network for performing UE positioning, where some UE positioning mechanisms may have unique demands from the network and/or some services may demand/specify very high positioning accuracy. For example, services that specify high positioning accuracy and low latency may include automated guided vehicle (AGV) tracking for navigation and collision avoidance, and also include certain industrial automation use cases. In addition, certain positioning services are starting to become very complex to implement and manage, such as positioning services related to: (1) DL and UL TDOA, RTT, DL-AOD, and UL-AoA; (2) positioning in an RRC inactive mode; (3) sidelink (SL) mode 1, SL mode 2, and SL+Uu; (4) low power and high accuracy mode, hopping mode for reduced capability (Redcap) UEs, carrier phase methods; (5) machine learning (ML) enabled positioning with site specific ML models, ML enhanced classical algorithms; (6) positioning for ambient Internet-of-Things (IoT) devices (e.g., passive devices with backscattering or minimal energy storage); (7) radio frequency (RF) sensing for multiple home, industry, and enterprise use cases; and/or (8) NR+Wi-Fi, NR+GNSS fusion, etc. In some examples, these services may collectively be referred to as “non-data services.”

In some examples, performing high accuracy positioning (e.g., by a UE, a network entity, and/or a location server, etc.) may specify dedicated physical layer resources such as high bandwidth (BW), and intensive computing engines at a radio unit (RU) and/or a distributed unit (DU), etc., for processing positioning related signals (e.g., positioning reference signal (PRS), sounding reference signal (SRS), etc.). In other examples, performing high accuracy positioning may also specify dedicated hardware (HW) and software (SW) for control and management of all the transmission reception points (TRPs) and UEs (and Wi-Fi access points (APs)) for the various positioning mechanisms. In another example, performing high accuracy positioning may also specify dedicated HW and SW in a core network (CN) (e.g., a location server, an LMF, etc.) for implementing a final location computation and handling requests from external servers.

Aspects presented herein may improve the accuracy, latency, and/or reliability of UE positioning/sensing by enabling dedicated network slices to be defined and configured for UE positioning/sensing (e.g., RF sensing). In one aspect of the present disclosure, positioning/sensing specific network slices and slice differentiators (SDs) may be defined and configured for positioning/sensing entities (e.g., a UE, a base station/TRP, an LMF, etc.). For example, one or more standard SST values may be introduced/configured for positioning/sensing related services. If more than one SST value is introduced/configured, the SST value(s) may map (e.g., implicitly) to one or more positioning/sensing modes, where the one or more positioning modes (e.g., as described in connection with FIG. 4) may be associated with a high accuracy positioning/sensing slice, a low latency positioning/sensing slice, a low power positioning/sensing slice, an ML-enabled positioning/sensing slice, and/or a Uu/SL-hybrid positioning slice, etc. The positioning/sensing specific network slices and SDs may also be configured to support non-standardized SST values for differentiating positioning/sensing services, and/or support SD signaling for various positioning/sensing modes.

In another aspect of the present disclosure, a UE may indicate positioning or sensing specific slice information to an AMF during a registration process, and the AMF may forward this information to a location server (e.g., an LMF) when a positioning/sensing session is initiated. In one implementation, a UE may indicate positioning specific slice information directly to the location server when the positioning session is initiated (e.g., through LTE positioning protocol (LPP)). In another implementation, if one or more S-NSSAIs or SDs are indicated to the location server (by a network entity), then the location server may indicate one S-NSSAI or SD to the UE. This may be specified to be provided to the AMF as well, directly or by the UE. In another implementation, if the UE is in an RRC inactive mode or an RRC idle mode, the UE may provide a positioning NSSAI (e.g., a suitable or desired NSSAI) in an RRC connection request message or an RRC resume request message which initiates the positioning/sensing session.

In another aspect of the present disclosure, after a UE is registered to a network and is in an RRC connected mode (e.g., with a base station or network entity), the UE may provide an S-NSSAI value or a list of S-NSSAI values accepted to the location server, such as via a registration accept message. As an alternative or additionally, the UE may provide this information as part of positioning session request message. In one example, the location server may suggest S-NSSAI value to a RAN (e.g., to TRP(s) involved in the positioning/sensing session) based on (e.g., from) the list of S-NSSAI values provided by the UE. In some scenarios, the location server may also suggest S-NSSAI value(s) that are outside of the list of S-NSSAI values provide by the UE. In this case, the UE may be specified to re-register/update the S-NSSAI value to the network. In another example, the location server may include the capability to provide different S-NSSAI values for different positioning modes, and/or the location server may include the capability to provide different S-NSSAI values for different positioning links (e.g., Uu link, SL link, etc.).

In another aspect of the present disclosure, for a UE in an RRC inactive mode and/or RRC idle mode, the location server may provide a list of suitable or desired S-NSSAI to the UE in the assistant data. In some examples, it may be pp to the UE implementation on how to use the list of S-NSSAI in the assistance data. In some scenarios, a UE may be configured with S-NSSAI associated with radio resource management (RRM) (e.g., data services, certain non-positioning/sensing services, etc.) and S-NSSAI associated with positioning/sensing, and the UE may be specified to prioritize the RRM S-NSSAI over positioning/sensing S-NSSAI or vice versa.

Based on the network slicing described herein, businesses with multiple applications may allocate different latency or bandwidth capabilities to specific systems that have a greater capacity specification, such as IoT-enabled smart meters. A single network may be used to offer various services based on the specifications/demands of the user and various use cases. Network operators may also be able to allocate the right number of specified resources as per network slice. Hence, aspects presented herein may provide a more effective and efficient utilization of resources. For example, one network slice may be designed/configured to deliver low latency and low data rate while another network slice may be designed/configured to deliver a high throughput, etc. Aspects presented herein may also enable network operators to reduce operating expenses (OPEX) and capital expenditure (CAPEX). Aspects presented herein also vastly improve operational efficiency and time to market for the delivery of network services. Aspects presented here may also overcome drawbacks associated with differentiated services (DiffServ), which may be one of most popular QoS solutions. DiffServ may refer to a computer networking architecture that specifies a mechanism for classifying and managing network traffic, or refer to a protocol for specifying and controlling network traffic by class so that certain types of traffic get precedence, etc.

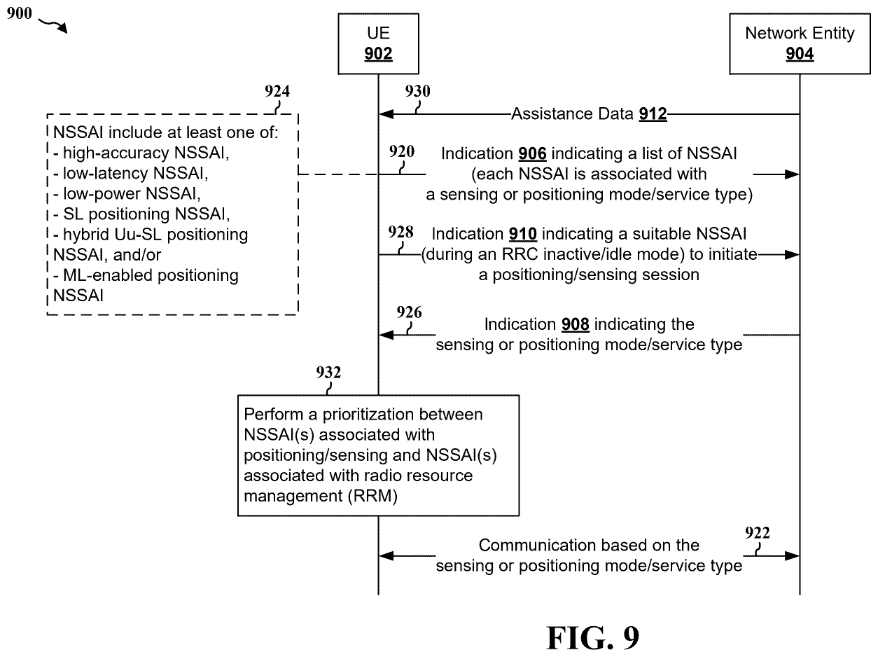

FIG. 9 is a communication flow 900 illustrating an example of a network entity configuring network slice(s) associated with positioning/sensing for a UE in accordance with various aspects of the present disclosure. The numberings associated with the communication flow 900 do not specify a particular temporal order and are merely used as references for the communication flow 900.

At 920, a UE 920 may transmit, to a network entity 904, an indication 906 indicating a list of NSSAI, where each NSSAI in the list of NSSAI may be associated with at least one of a positioning mode, a sensing mode, a positioning-specific service type, or a sensing-specific service type, etc. In one example, the UE 902 may transmit the indication 906 during an RRC connected mode via a positioning session request message. For purposes of the present disclosure, the positioning mode, the sensing mode, the positioning-specific service type, and/or the sensing-specific service type may include at least positioning/sensing modes associated with: (1) DL and UL TDOA, RTT, DL-AOD, and UL-AoA; (2) positioning in an RRC inactive mode; (3) SL mode 1, SL mode 2, and SL+Uu; (4) low power and high accuracy mode, hopping mode for reduced capability UEs, carrier phase methods; (5) ML enabled positioning with site specific ML models, ML enhanced classical algorithms; (6) positioning for ambient IoT devices (e.g., passive devices with backscattering or minimal energy storage); (7) RF sensing for multiple home, industry, and enterprise use cases, (8) NR+Wi-Fi, NR+GNSS fusion, or a combination thereof. In some examples, these services may collectively be referred to as “non-data services.”

At 922, based at least in part on the indication 906, the UE 902 may communicate with the network entity based on at least one of the positioning mode, the sensing mode, the positioning-specific service type, or the sensing-specific service type. In one example, the UE 902 may also communicate with the network entity 904 based on NSSAI not in the list of NSSAI. For example, if the network entity 904 determines that the list of NSSAI provided by the UE 902 are not suitable for the UE 902 (or the network entity 904 is unable to provide the list of NSSAI provided by the UE 902), the network entity 904 may provide NSSAI to the UE 902 that is not in the list of NSSAI provided by the UE 902.

In one aspect of the present disclosure, as shown at 924, the NSSAI (or the list of NSSAI) may include high-accuracy NSSAI, low-latency NSSAI, low-power NSSAI, SL positioning NSSAI, hybrid UE-UTRAN (Uu)-SL positioning NSSAI, and/or machine learning (ML)-enabled positioning NSSAI, etc. For example, the high-accuracy NSSAI may be associated with a positioning/sensing mechanism/mode that specifies the accuracy/reliability of the positioning/sensing to meet a defined accuracy/reliability threshold (e.g., a high accuracy/reliability threshold), the low-latency NSSAI may be associated with a positioning/sensing mechanism/mode that specifies the latency of the positioning/sensing to meet a latency/time threshold (e.g., a low latency threshold), the low-power NSSAI may be associated with a positioning/sensing mechanism/mode that specifies the power consumption of the positioning/sensing to meet a power threshold (e.g., a low power threshold), the SL positioning NSSAI/Uu-SL positioning NSSAI may be associated with a positioning/sensing mechanism/mode that is based at least in part on SL communications, and the ML-enabled positioning NSSAI may be associated with a positioning/sensing mechanism/mode that specifies using at least one ML model for positioning/sensing, etc.

In another aspect of the present disclosure, as described in connection with FIG. 6, each NSSAI in the list of NSSAI may include at least one SST value or at least one SD value, and different SST values or different SD values may correspond to different positioning modes or services, or to different sensing modes or services. For example, a first SST value may correspond to a first positioning mode (e.g., positioning based on TDoA), a second SST value may correspond to a first sensing mode (e.g., mono-static sensing), a third SST value may correspond to a second positioning mode (e.g., positioning based on AoA), and a fourth SST value may correspond to a second sensing mode (e.g., bi-static sensing), etc. In addition, SDs values may be used to define different services for the same positioning/sensing mode. For example, a first SD value associated with the first SST value (e.g., TDoA positioning) may indicate a high-accuracy positioning, and a second SD value associated with the first SST value may indicate a lower-accuracy positioning, etc.

In another aspect of the present disclosure, as shown at 926, based on the indication 906 that includes the list of NSSAI from the UE 902, the network entity 904 may transmit, to the UE 902, an indication 908 indicating at least one of the positioning mode, the sensing mode, the positioning-specific service type, or the sensing-specific service type. For example, based on the list of NSSAI, the network entity 904 may select suitable NSSAI(s) from the list of NSSAI and indicate the selected NSSAI(s) to the UE 902. As an illustration, at 920, the UE 902 may indicate a list of NSSAI at includes NSSAI(s) for a first positioning mode (e.g., TDoA-based positioning), a second positioning mode (e.g., AoA/AoD-based positioning), a first sensing mode (e.g., mono-static sensing), and a second sensing mode (e.g., bi-static sensing), etc. In response, at 926, the network entity 904 may provide an NSSAI for the second positioning mode to the UE 902. In one example, the network entity 904 may determine which NSSAI(s) to provide/select based on the availabilities of NSSAI(s)/resources at the network entity 904, based on the accuracy/reliability specified for the positioning/sensing, based on capabilities of the UE 902, and/or based on certain pre-defined conditions/factors. In some examples, the network entity 904 may be an LMF, and for the UE 902 to transmit the indication 906 to the LMF, the UE 902 may either transmit the indication 906 directly to the LMF, or via an AMF. In response, the LMF may also transmit the indication 908 to the UE either directly or via the AMF.

In another aspect of the present disclosure, as shown at 928, the UE 902 may transmit, during an RRC inactive mode and/or an RRC idle mode, an indication 910 indicating a suitable or desired NSSAI based on the list of NSSAI to initiate a positioning session or a sensing session. In some examples, the UE 902 may transmit the indication 910 to the network entity 904 via an RRC connection request message or an RRC resume request message.

In another aspect of the present disclosure, as shown at 930, the network entity 904 may transmit assistance data 912 to the UE 902, where the assistance data 912 may include a list of suitable or desired NSSAI. In response, the UE 902 may select the list of NSSAI(s) (e.g., at 920) based on this list of suitable or desired NSSAI from the network entity 904. In some examples, the network entity 904 may transmit the list of suitable or desired NSSAI(s) to the UE 902 when the UE is in an RRC inactive mode or an RRC idle mode. For example, at 930, the network entity 904 may provide a list of NSSAI(s) that include NSSAI(s) for a first positioning mode (e.g., TDoA-based positioning), a second positioning mode (e.g., AoA/AoD-based positioning), a first sensing mode (e.g., mono-static sensing), and a second sensing mode (e.g., bi-static sensing), etc. In response, the UE 902 may select NSSAI(s) for the first positioning mode and the first sensing mode, and indicate/include the selected NSSAI(s) in the indication 906 at 920.

In another aspect of the present disclosure, as shown at 932, in some scenarios, the UE 902 may be configured with NSSAI(s) that are associated with positioning/sensing and/or NSSAI(s) that are associated with radio resource management (RRM) (e.g., for communication, non-positioning/sensing operations, etc.). In such scenarios, if the UE 902 is unable to (e.g., does not have resource to) utilize all NSSAI(s), the UE 902 may be configured to perform a prioritization for these NSSAI(s), such as based on a pre-defined rule or based on its resources. For example, the UE 902 may be specified to prioritize positioning/sensing related NSSAI(s) over RRM related NSSAI(s), or prioritize RRM related NSSAI(s) over positioning/sensing related NSSAI(s). In some examples, the UE 902 may also be specified to prioritize different prioritize positioning/sensing related NSSAIs. For example, if the UE 902 receives or is configured with two NSSAIs that are associated with different positioning/sensing modes, the UE 902 may be specified to prioritize one of the positioning/sensing modes, such as by selecting the positioning/sensing mode with highest accuracy/reliability.

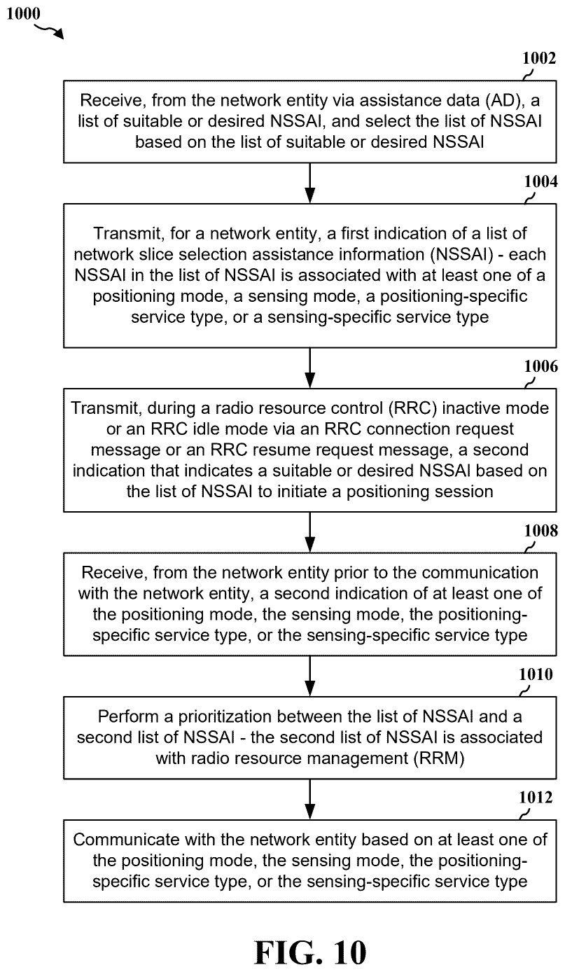

FIG. 10 is a flowchart 1000 of a method of wireless communication. The method may be performed by a UE (e.g., the UE 104, 404, 902; the apparatus 1204). The method may enable the UE to indicate NSSAI associated with positioning and/or sensing to a network entity, and communicate with the network entity based on the indicated NSSAI.

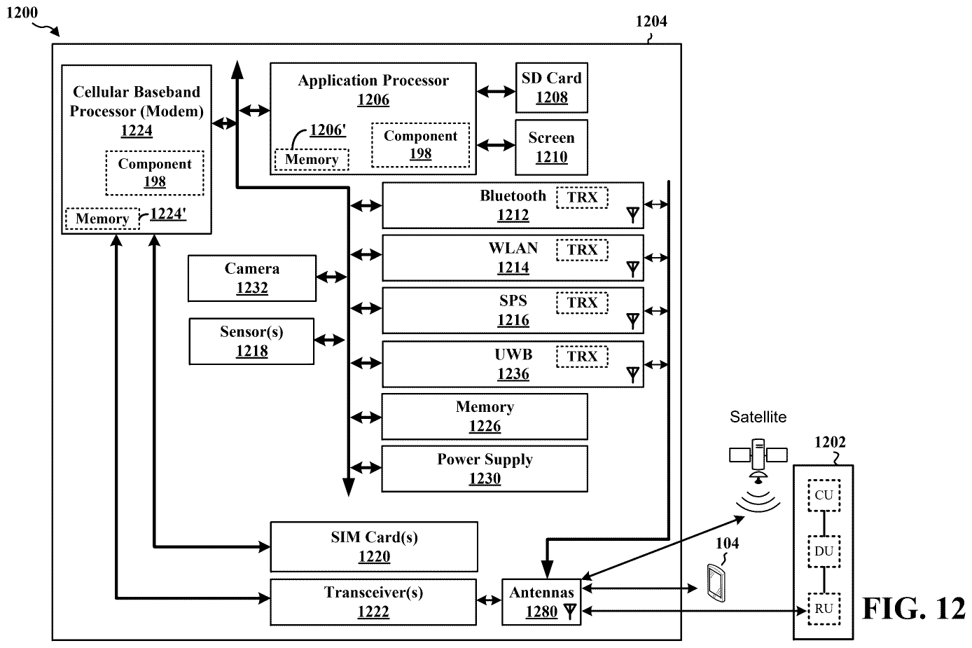

At 1004, the UE may transmit, for a network entity, a first indication of a list of NSSAI, where each NSSAI in the list of NSSAI is associated with at least one of a positioning mode, a sensing mode, a positioning-specific service type, or a sensing-specific service type, such as described in connection with FIG. 9. For example, as shown at 920 of FIG. 9, the UE 902 may transmit an indication 906 to the network entity 904, where the indication 906 may include a list of NSSAI that is associate with one or more sensing or positioning modes/service types. The transmission of the first indication may be performed by, e.g., the NSSAI request component 198, the application processor 1206, the cellular baseband processor 1224, and/or the transceiver(s) 1222 of the apparatus 1204 in FIG. 12.

In one example, the NSSAI may include at least one of: high-accuracy NSSAI, low-latency NSSAI, low-power NSSAI, SL positioning NSSAI, hybrid Uu-SL positioning NSSAI, or ML-enabled positioning NSSAI.

In another example, each NSSAI in the list of NSSAI may include at least one SST value or at least one SD value, and where different SST values or different SD values correspond to different positioning modes or services, or to different sensing modes or services.

In another example, the first indication may be transmitted during an RRC connected mode via a positioning session request message.

At 1012, the UE may communicate with the network entity based on at least one of the positioning mode, the sensing mode, the positioning-specific service type, or the sensing-specific service type, such as described in connection with FIG. 9. For example, as shown at 922 of FIG. 9, the UE 902 may communicate with the network entity 904 based on at least one of the positioning or sensing modes/service types. The communication with the network entity may be performed by, e.g., the NSSAI request component 198, the application processor 1206, the cellular baseband processor 1224, and/or the transceiver(s) 1222 of the apparatus 1204 in FIG. 12.

In one example, the UE may communicate with the network entity based on NSSAI not in the list of NSSAI.

In another example, at 1008, the UE may receive, from the network entity prior to the communication with the network entity, a second indication of at least one of the positioning mode, the sensing mode, the positioning-specific service type, or the sensing-specific service type, such as described in connection with FIG. 9. For example, as shown at 926 of FIG. 9, the UE 902 may receive, from the network entity 904 prior to the communication with the network entity 904, an indication 908 indicating at least one of the positioning or sensing modes/service types. The reception of the second indication may be performed by, e.g., the NSSAI request component 198, the application processor 1206, the cellular baseband processor 1224, and/or the transceiver(s) 1222 of the apparatus 1204 in FIG. 12. In some implementations, the network entity may correspond to an LMF, and the UE may transmit the first indication directly to the LMF, or transmit the first indication to the LMF via an AMF. Then, the UE may receive the second indication directly from the LMF, or receive the second indication from the LMF via the AMF.

In another example, at 1006, the UE may transmit, during an RRC inactive mode or an RRC idle mode via an RRC connection request message or an RRC resume request message, a second indication that indicates a suitable or desired NSSAI based on the list of NSSAI to initiate a positioning session, such as described in connection with FIG. 9. For example, as shown at 928 of FIG. 9, the UE 902 may transmit, to the network entity 904 during an RRC inactive/idle mode, an indication 910 indicating a suitable or desired NSSAI to initiate a positioning/sensing session. The transmission of the second indication may be performed by, e.g., the NSSAI request component 198, the application processor 1206, the cellular baseband processor 1224, and/or the transceiver(s) 1222 of the apparatus 1204 in FIG. 12.

In another example, at 1002, the UE may receive, from the network entity via assistance data (AD), a list of suitable or desired NSSAI, and select the list of NSSAI based on the list of suitable or desired NSSAI, such as described in connection with FIG. 9. For example, as shown at 930 of FIG. 9, the UE 902 may receive, from the network entity 904 via assistance data 912, a list of suitable or desired NSSAI, and the UE 902 may select the list of NSSAI based on the list of suitable or desired NSSAI. The reception of the list of suitable or desired NSSAI and/or the selection of the list of NSSAI may be performed by, e.g., the NSSAI request component 198, the application processor 1206, the cellular baseband processor 1224, and/or the transceiver(s) 1222 of the apparatus 1204 in FIG. 12. In some implementations, the list of suitable or desired NSSAI may be received during an RRC inactive mode or an RRC idle mode.

In another example, at 1010, the UE may perform a prioritization between the list of NSSAI and a second list of NSSAI, where the second list of NSSAI is associated with RRM, such as described in connection with FIG. 9. For example, as shown at 932 of FIG. 9, the UE 902 perform a prioritization between NSSAI(s) associated with positioning/sensing and NSSAI(s) associated with RRM. The prioritization of between the list of NSSAI and a second list of NSSAI may be performed by, e.g., the NSSAI request component 198, the application processor 1206, the cellular baseband processor 1224, and/or the transceiver(s) 1222 of the apparatus 1204 in FIG. 12.

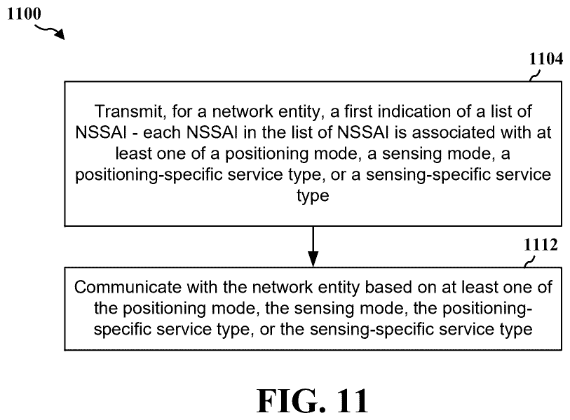

FIG. 11 is a flowchart 1100 of a method of wireless communication. The method may be performed by a UE (e.g., the UE 104, 404, 902; the apparatus 1204). The method may enable the UE to indicate NSSAI associated with positioning and/or sensing to a network entity, and communicate with the network entity based on the indicated NSSAI.

At 1104, the UE may transmit, for a network entity, a first indication of a list of NSSAI, where each NSSAI in the list of NSSAI is associated with at least one of a positioning mode, a sensing mode, a positioning-specific service type, or a sensing-specific service type, such as described in connection with FIG. 9. For example, as shown at 920 of FIG. 9, the UE 902 may transmit an indication 906 to the network entity 904, where the indication 906 may include a list of NSSAI that is associate with one or more sensing or positioning modes/service types. The transmission of the first indication may be performed by, e.g., the NSSAI request component 198, the application processor 1206, the cellular baseband processor 1224, and/or the transceiver(s) 1222 of the apparatus 1204 in FIG. 12.

In one example, the NSSAI may include at least one of: high-accuracy NSSAI, low-latency NSSAI, low-power NSSAI, SL positioning NSSAI, hybrid Uu-SL positioning NSSAI, or ML-enabled positioning NSSAI.

In another example, each NSSAI in the list of NSSAI may include at least one SST value or at least one SD value, and where different SST values or different SD values correspond to different positioning modes or services, or to different sensing modes or services.

In another example, the first indication may be transmitted during an RRC connected mode via a positioning session request message.

At 1112, the UE may communicate with the network entity based on at least one of the positioning mode, the sensing mode, the positioning-specific service type, or the sensing-specific service type, such as described in connection with FIG. 9. For example, as shown at 922 of FIG. 9, the UE 902 may communicate with the network entity 904 based on at least one of the positioning or sensing modes/service types. The communication with the network entity may be performed by, e.g., the NSSAI request component 198, the application processor 1206, the cellular baseband processor 1224, and/or the transceiver(s) 1222 of the apparatus 1204 in FIG. 12.

In one example, the UE may communicate with the network entity based on NSSAI not in the list of NSSAI.

In another example, the UE may receive, from the network entity prior to the communication with the network entity, a second indication of at least one of the positioning mode, the sensing mode, the positioning-specific service type, or the sensing-specific service type, such as described in connection with FIG. 9. For example, as shown at 926 of FIG. 9, the UE 902 may receive, from the network entity 904 prior to the communication with the network entity 904, an indication 908 indicating at least one of the positioning or sensing modes/service types. The reception of the second indication may be performed by, e.g., the NSSAI request component 198, the application processor 1206, the cellular baseband processor 1224, and/or the transceiver(s) 1222 of the apparatus 1204 in FIG. 12. In some implementations, the network entity may correspond to an LMF, and the UE may transmit the first indication directly to the LMF, or transmit the first indication to the LMF via an AMF. Then, the UE may receive the second indication directly from the LMF, or receive the second indication from the LMF via the AMF.

In another example, the UE may transmit, during an RRC inactive mode or an RRC idle mode via an RRC connection request message or an RRC resume request message, a second indication that indicates a suitable or desired NSSAI based on the list of NSSAI to initiate a positioning session, such as described in connection with FIG. 9. For example, as shown at 928 of FIG. 9, the UE 902 may transmit, to the network entity 904 during an RRC inactive/idle mode, an indication 910 indicating a suitable or desired NSSAI to initiate a positioning/sensing session. The transmission of the second indication may be performed by, e.g., the NSSAI request component 198, the application processor 1206, the cellular baseband processor 1224, and/or the transceiver(s) 1222 of the apparatus 1204 in FIG. 12.

In another example, the UE may receive, from the network entity via assistance data (AD), a list of suitable or desired NSSAI, and select the list of NSSAI based on the list of suitable or desired NSSAI, such as described in connection with FIG. 9. For example, as shown at 930 of FIG. 9, the UE 902 may receive, from the network entity 904 via assistance data 912, a list of suitable or desired NSSAI, and the UE 902 may select the list of NSSAI based on the list of suitable or desired NSSAI. The reception of the list of suitable or desired NSSAI and/or the selection of the list of NSSAI may be performed by, e.g., the NSSAI request component 198, the application processor 1206, the cellular baseband processor 1224, and/or the transceiver(s) 1222 of the apparatus 1204 in FIG. 12. In some implementations, the list of suitable or desired NSSAI may be received during an RRC inactive mode or an RRC idle mode.

In another example, the UE may perform a prioritization between the list of NSSAI and a second list of NSSAI, where the second list of NSSAI is associated with RRM, such as described in connection with FIG. 9. For example, as shown at 932 of FIG. 9, the UE 902 perform a prioritization between NSSAI(s) associated with positioning/sensing and NSSAI(s) associated with RRM. The prioritization of between the list of NSSAI and a second list of NSSAI may be performed by, e.g., the NSSAI request component 198, the application processor 1206, the cellular baseband processor 1224, and/or the transceiver(s) 1222 of the apparatus 1204 in FIG. 12.

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include a cellular baseband processor 1224 (also referred to as a modem) coupled to one or more transceivers 1222 (e.g., cellular RF transceiver). The cellular baseband processor 1224 may include on-chip memory 1224′. In some aspects, the apparatus 1204 may further include one or more subscriber identity modules (SIM) cards 1220 and an application processor 1206 coupled to a secure digital (SD) card 1208 and a screen 1210. The application processor 1206 may include on-chip memory 1206′. In some aspects, the apparatus 1204 may further include a Bluetooth module 1212, a WLAN module 1214, an SPS module 1216 (e.g., GNSS module), an ultra-wideband (UWB) module 1236, one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, the UWB module 1236, and the SPS module 1216 may include an on-chip transceiver (TRX) (or in some cases, just a receiver (RX)). The Bluetooth module 1212, the WLAN module 1214, the UWB module 1236, and the SPS module 1216 may include their own dedicated antennas and/or utilize the antennas 1280 for communication. The cellular baseband processor 1224 communicates through the transceiver(s) 1222 via one or more antennas 1280 with the UE 104 and/or with an RU associated with a network entity 1202. The cellular baseband processor 1224 and the application processor 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor 1224 and the application processor 1206 are each responsible for general processing, including the execution of software stored on the computer-readable medium/memory. The software, when executed by the cellular baseband processor 1224/application processor 1206, causes the cellular baseband processor 1224/application processor 1206 to perform the various functions described supra. The computer-readable medium/memory may also be used for storing data that is manipulated by the cellular baseband processor 1224/application processor 1206 when executing software. The cellular baseband processor 1224/application processor 1206 may be a component of the UE 350 and may include the memory 360 and/or at least one of the TX processor 368, the RX processor 356, and the controller/processor 359. In one configuration, the apparatus 1204 may be a processor chip (modem and/or application) and include just the cellular baseband processor 1224 and/or the application processor 1206, and in another configuration, the apparatus 1204 may be the entire UE (e.g., see UE 350 of FIG. 3) and include the additional modules of the apparatus 1204.

As discussed supra, the NSSAI request component 198 may be configured to transmit, for a network entity, a first indication of a list of NSSAI, where each NSSAI in the list of NSSAI is associated with at least one of a positioning mode, a sensing mode, a positioning-specific service type, or a sensing-specific service type. The NSSAI request component 198 may also be configured to communicate with the network entity based on at least one of the positioning mode, the sensing mode, the positioning-specific service type, or the sensing-specific service type. The NSSAI request component 198 may be within the cellular baseband processor 1224, the application processor 1206, or both the cellular baseband processor 1224 and the application processor 1206. The NSSAI request component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1204 may include a variety of components configured for various functions. In one configuration, the apparatus 1204, and in particular the cellular baseband processor 1224 and/or the application processor 1206, may include means for transmitting, for a network entity, a first indication of a list of NSSAI, where each NSSAI in the list of NSSAI is associated with at least one of a positioning mode, a sensing mode, a positioning-specific service type, or a sensing-specific service type. The apparatus 1204 may further include means for communicating with the network entity based on at least one of the positioning mode, the sensing mode, the positioning-specific service type, or the sensing-specific service type.

In one configuration, the NSSAI may include at least one of: high-accuracy NSSAI, low-latency NSSAI, low-power NSSAI, SL positioning NSSAI, hybrid Uu-SL positioning NSSAI, or ML-enabled positioning NSSAI.

In another configuration, each NSSAI in the list of NSSAI may include at least one SST value or at least one SD value, and where different SST values or different SD values correspond to different positioning modes or services, or to different sensing modes or services.

In another configuration, the first indication may be transmitted during an RRC connected mode via a positioning session request message.

In another configuration, the apparatus 1204 may communicate with the network entity based on NSSAI not in the list of NSSAI.

In another configuration, the apparatus 1204 may further include means for receiving, from the network entity prior to the communication with the network entity, a second indication of at least one of the positioning mode, the sensing mode, the positioning-specific service type, or the sensing-specific service type. In some implementations, the network entity may correspond to an LMF, and the apparatus 1204 may further include means for transmitting the first indication directly to the LMF, or means for transmitting the first indication to the LMF via an AMF. The apparatus 1204 may further include means for receiving the second indication directly from the LMF, or means for receiving the second indication from the LMF via the AMF.

In another configuration, the apparatus 1204 may further include means for transmitting, during an RRC inactive mode or an RRC idle mode via an RRC connection request message or an RRC resume request message, a second indication that indicates a suitable or desired NSSAI based on the list of NSSAI to initiate a positioning session.

In another configuration, the apparatus 1204 may further include means for receiving, from the network entity via assistance data (AD), a list of suitable or desired NSSAI, and means for selecting the list of NSSAI based on the list of suitable or desired NSSAI. In some implementations, the list of suitable or desired NSSAI may be received during an RRC inactive mode or an RRC idle mode.

In another configuration, the apparatus 1204 may further include means for performing a prioritization between the list of NSSAI and a second list of NSSAI, where the second list of NSSAI may be associated with RRM.

The means may be the NSSAI request component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

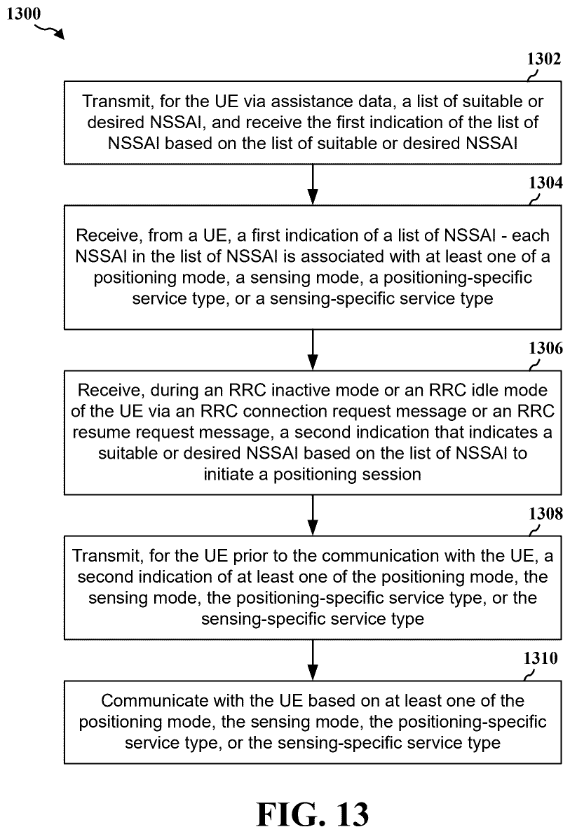

FIG. 13 is a flowchart 1300 of a method of wireless communication. The method may be performed by a network entity (e.g., the base station 102; the network entity 904, 1502). The method may enable the network entity to provide positioning and/or sensing associated NSSAI to a UE based on a list of NSSAI provided/requested by the UE.

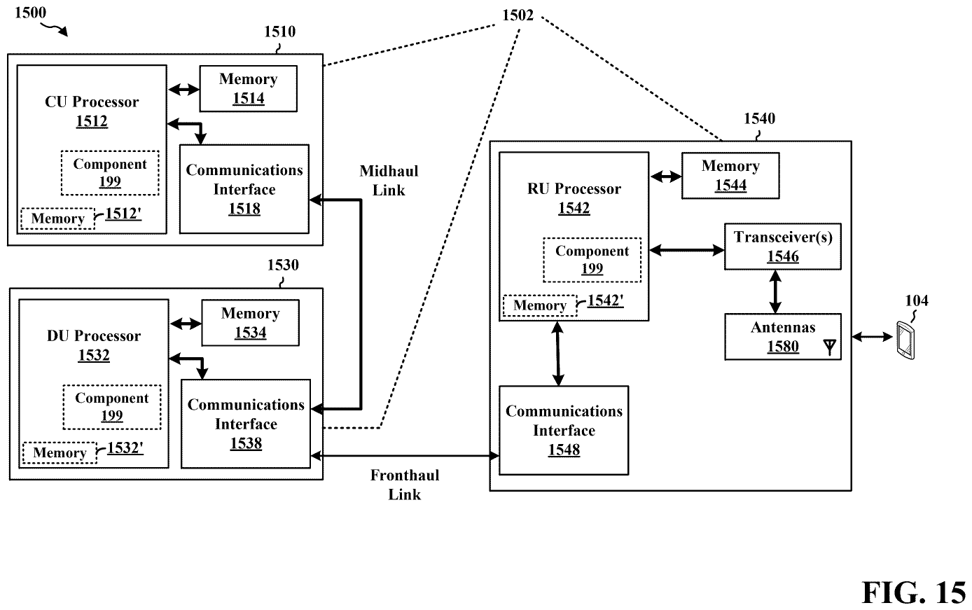

At 1304, the network entity may receive, from a UE, a first indication of a list of NSSAI, where each NSSAI in the list of NSSAI may be associated with at least one of a positioning mode, a sensing mode, a positioning-specific service type, or a sensing-specific service type, such as described in connection with FIG. 9. For example, as shown at 920 of FIG. 9, the network entity 904 may receive an indication 906 from the UE 902, where the indication 906 may include a list of NSSAI that is associate with one or more sensing or positioning modes/service types. The reception of the first indication may be performed by, e.g., the NSSAI provide component 199, the RU processor 1542, and/or the transceiver(s) 1546 of the network entity 1502 in FIG. 15.

In one example, the NSSAI may include at least one of: high-accuracy NSSAI, low-latency NSSAI, low-power NSSAI, SL positioning NSSAI, hybrid Uu-SL positioning NSSAI, or ML-enabled positioning NSSAI.

In another example, each NSSAI in the list of NSSAI may include at least one SST value or at least one SD value, and where different SST values or different SD values correspond to different positioning modes or services, or to different sensing modes or services.

In another example, the first indication may be received during an RRC connected mode of the UE via a positioning session request message.

At 1310, the network entity may communicate with the UE based on at least one of the positioning mode, the sensing mode, the positioning-specific service type, or the sensing-specific service type, such as described in connection with FIG. 9. For example, as shown at 922 of FIG. 9, the network entity 904 may communicate with the UE 902 based on at least one of the positioning or sensing modes/service types. The communication with the UE may be performed by, e.g., the NSSAI provide component 199, the RU processor 1542, and/or the transceiver(s) 1546 of the network entity 1502 in FIG. 15.

In one example, at 1308, the network entity may transmit, for the UE prior to the communication with the UE, a second indication of at least one of the positioning mode, the sensing mode, the positioning-specific service type, or the sensing-specific service type, such as described in connection with FIG. 9. For example, as shown at 926 of FIG. 9, the network entity 904 may transmit, to the UE 902 prior to the communication with the UE 902, an indication 908 indicating at least one of the positioning or sensing modes/service types. The transmission of the second indication may be performed by, e.g., the NSSAI provide component 199, the RU processor 1542, and/or the transceiver(s) 1546 of the network entity 1502 in FIG. 15. In some implementations, the network entity may correspond to an LMF, and the network entity may receive the first indication directly from the UE, or receive the first indication from the UE via an AMF. Then, the network entity may transmit the second indication directly to the UE, or transmit the second indication to the UE via the AMF.

In another example, at 1306, the network entity may receive, during an RRC inactive mode or an RRC idle mode of the UE via an RRC connection request message or an RRC resume request message, a second indication that indicates a suitable or desired NSSAI based on the list of NSSAI to initiate a positioning session, such as described in connection with FIG. 9. For example, as shown at 928 of FIG. 9, the network entity 904 may receive, from the UE 902 during an RRC inactive/idle mode of the UE 902, an indication 910 indicating a suitable or desired NSSAI to initiate a positioning/sensing session. The reception of the second indication may be performed by, e.g., the NSSAI provide component 199, the RU processor 1542, and/or the transceiver(s) 1546 of the network entity 1502 in FIG. 15.

In another example, the network entity may correspond to an LMF, and the network entity may transmit a list of suitable or desired NSSAI to a RAN that is associated with the UE. In some implementations, the list of suitable or desired NSSAI may be selected from the list of NSSAI, or may be selected from outside the list of NSSAI.

In another example, at 1302, the network entity may transmit, for the UE via assistance data, a list of suitable or desired NSSAI, and receive the first indication of the list of NSSAI based on the list of suitable or desired NSSAI, such as described in connection with FIG. 9. For example, as shown at 930 of FIG. 9, the network entity 904 may transmit, to the UE 902 via assistance data 912, a list of suitable or desired NSSAI, and the UE 902 may select the list of NSSAI based on the list of suitable or desired NSSAI. The transmission of the assistance data and/or the reception of the first indication may be performed by, e.g., the NSSAI provide component 199, the RU processor 1542, and/or the transceiver(s) 1546 of the network entity 1502 in FIG. 15. In some implementations, the list of suitable or desired NSSAI may be transmitted during an RRC inactive mode or an RRC idle mode of the UE.

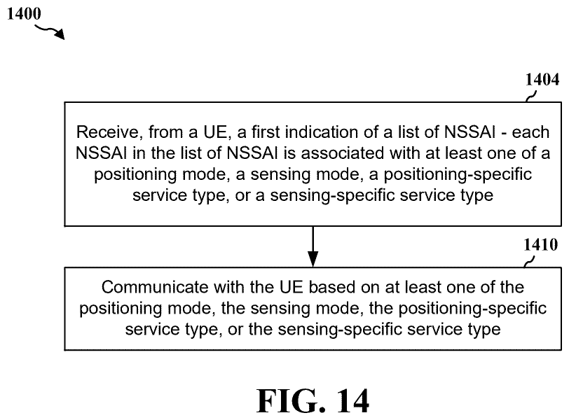

FIG. 14 is a flowchart 1400 of a method of wireless communication. The method may be performed by a network entity (e.g., the base station 102; the network entity 904, 1502). The method may enable the network entity to provide positioning and/or sensing associated NSSAI to a UE based on a list of NSSAI provided/requested by the UE.

At 1404, the network entity may receive, from a UE, a first indication of a list of NSSAI, where each NSSAI in the list of NSSAI may be associated with at least one of a positioning mode, a sensing mode, a positioning-specific service type, or a sensing-specific service type, such as described in connection with FIG. 9. For example, as shown at 920 of FIG. 9, the network entity 904 may receive an indication 906 from the UE 902, where the indication 906 may include a list of NSSAI that is associate with one or more sensing or positioning modes/service types. The reception of the first indication may be performed by, e.g., the NSSAI provide component 199, the RU processor 1542, and/or the transceiver(s) 1546 of the network entity 1502 in FIG. 15.

In one example, the NSSAI may include at least one of: high-accuracy NSSAI, low-latency NSSAI, low-power NSSAI, SL positioning NSSAI, hybrid Uu-SL positioning NSSAI, or ML-enabled positioning NSSAI.

In another example, each NSSAI in the list of NSSAI may include at least one SST value or at least one SD value, and where different SST values or different SD values correspond to different positioning modes or services, or to different sensing modes or services.

In another example, the first indication may be received during an RRC connected mode of the UE via a positioning session request message.

At 1410, the network entity may communicate with the UE based on at least one of the positioning mode, the sensing mode, the positioning-specific service type, or the sensing-specific service type, such as described in connection with FIG. 9. For example, as shown at 922 of FIG. 9, the network entity 904 may communicate with the UE 902 based on at least one of the positioning or sensing modes/service types. The communication with the UE may be performed by, e.g., the NSSAI provide component 199, the RU processor 1542, and/or the transceiver(s) 1546 of the network entity 1502 in FIG. 15.

In one example, the network entity may transmit, for the UE prior to the communication with the UE, a second indication of at least one of the positioning mode, the sensing mode, the positioning-specific service type, or the sensing-specific service type, such as described in connection with FIG. 9. For example, as shown at 926 of FIG. 9, the network entity 904 may transmit, to the UE 902 prior to the communication with the UE 902, an indication 908 indicating at least one of the positioning or sensing modes/service types. The transmission of the second indication may be performed by, e.g., the NSSAI provide component 199, the RU processor 1542, and/or the transceiver(s) 1546 of the network entity 1502 in FIG. 15. In some implementations, the network entity may correspond to an LMF, and the network entity may receive the first indication directly from the UE, or receive the first indication from the UE via an AMF. Then, the network entity may transmit the second indication directly to the UE, or transmit the second indication to the UE via the AMF.

In another example, the network entity may receive, during an RRC inactive mode or an RRC idle mode of the UE via an RRC connection request message or an RRC resume request message, a second indication that indicates a suitable or desired NSSAI based on the list of NSSAI to initiate a positioning session, such as described in connection with FIG. 9. For example, as shown at 928 of FIG. 9, the network entity 904 may receive, from the UE 902 during an RRC inactive/idle mode of the UE 902, an indication 910 indicating a suitable or desired NSSAI to initiate a positioning/sensing session. The reception of the second indication may be performed by, e.g., the NSSAI provide component 199, the RU processor 1542, and/or the transceiver(s) 1546 of the network entity 1502 in FIG. 15.

In another example, the network entity may correspond to an LMF, and the network entity may transmit a list of suitable or desired NSSAI to a RAN that is associated with the UE. In some implementations, the list of suitable or desired NSSAI may be selected from the list of NSSAI, or may be selected from outside the list of NSSAI.

In another example, the network entity may transmit, for the UE via assistance data, a list of suitable or desired NSSAI, and receive the first indication of the list of NSSAI based on the list of suitable or desired NSSAI, such as described in connection with FIG. 9. For example, as shown at 930 of FIG. 9, the network entity 904 may transmit, to the UE 902 via assistance data 912, a list of suitable or desired NSSAI, and the UE 902 may select the list of NSSAI based on the list of suitable or desired NSSAI. The transmission of the assistance data and/or the reception of the first indication may be performed by, e.g., the NSSAI provide component 199, the RU processor 1542, and/or the transceiver(s) 1546 of the network entity 1502 in FIG. 15. In some implementations, the list of suitable or desired NSSAI may be transmitted during an RRC inactive mode or an RRC idle mode of the UE.

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the NSSAI provide component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include a CU processor 1512. The CU processor 1512 may include on-chip memory 1512′. In some aspects, the CU 1510 may further include additional memory modules 1514 and a communications interface 1518. The CU 1510 communicates with the DU 1530 through a midhaul link, such as an F1 interface. The DU 1530 may include a DU processor 1532. The DU processor 1532 may include on-chip memory 1532′. In some aspects, the DU 1530 may further include additional memory modules 1534 and a communications interface 1538. The DU 1530 communicates with the RU 1540 through a fronthaul link. The RU 1540 may include an RU processor 1542. The RU processor 1542 may include on-chip memory 1542′. In some aspects, the RU 1540 may further include additional memory modules 1544, one or more transceivers 1546, antennas 1580, and a communications interface 1548. The RU 1540 communicates with the UE 104. The on-chip memory 1512′, 1532′, 1542′ and the additional memory modules 1514, 1534, 1544 may each be considered a computer-readable medium/memory. Each computer-readable medium/memory may be non-transitory. Each of the processors 1512, 1532, 1542 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the NSSAI provide component 199 may be configured to receive, from a UE, a first indication of a list of NSSAI, where each NSSAI in the list of NSSAI is associated with at least one of a positioning mode, a sensing mode, a positioning-specific service type, or a sensing-specific service type. The NSSAI provide component 199 may also be configured to communicate with the UE based on at least one of the positioning mode, the sensing mode, the positioning-specific service type, or the sensing-specific service type. The NSSAI provide component 199 may be within one or more processors of one or more of the CU 1510, DU 1530, and the RU 1540. The NSSAI provide component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1502 may include a variety of components configured for various functions. In one configuration, the network entity 1502 may include means for receiving, from a UE, a first indication of a list of NSSAI, where each NSSAI in the list of NSSAI is associated with at least one of a positioning mode, a sensing mode, a positioning-specific service type, or a sensing-specific service type. The network entity 1502 may further include means for communicating with the UE based on at least one of the positioning mode, the sensing mode, the positioning-specific service type, or the sensing-specific service type.

In one configuration, the NSSAI may include at least one of: high-accuracy NSSAI, low-latency NSSAI, low-power NSSAI, SL positioning NSSAI, hybrid Uu-SL positioning NSSAI, or ML-enabled positioning NSSAI.

In another configuration, each NSSAI in the list of NSSAI may include at least one SST value or at least one SD value, and where different SST values or different SD values correspond to different positioning modes or services, or to different sensing modes or services.

In another configuration, the first indication may be received during an RRC connected mode of the UE via a positioning session request message.

In another configuration, the network entity 1502 may further include means for transmitting, for the UE prior to the communication with the UE, a second indication of at least one of the positioning mode, the sensing mode, the positioning-specific service type, or the sensing-specific service type. In some implementations, the network entity 1502 may correspond to an LMF, and the network entity 1502 may further include means for receiving the first indication directly from the UE, or means for receiving the first indication from the UE via an AMF. The network entity 1502 may further include means for transmitting the second indication directly to the UE, or means for transmitting the second indication to the UE via the AMF.

In another configuration, the network entity 1502 may further include means for receiving, during an RRC inactive mode or an RRC idle mode of the UE via an RRC connection request message or an RRC resume request message, a second indication that indicates a suitable or desired NSSAI based on the list of NSSAI to initiate a positioning session.

In another configuration, the network entity 1502 may correspond to an LMF, and the network entity 1502 may further include means for transmitting a list of suitable or desired NSSAI to a RAN that is associated with the UE. In some implementations, the list of suitable or desired NSSAI may be selected from the list of NSSAI, or may be selected from outside the list of NSSAI.

In another configuration, the network entity 1502 may further include means for transmitting, for the UE via assistance data, a list of suitable or desired NSSAI, and means for receiving the first indication of the list of NSSAI based on the list of suitable or desired NSSAI. In some implementations, the list of suitable or desired NSSAI may be transmitted during an RRC inactive mode or an RRC idle mode of the UE.

The means may be the NSSAI provide component 199 of the network entity 1502 configured to perform the functions recited by the means. As described supra, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including: transmitting, for a network entity, a first indication of a list of NSSAI, where each NSSAI in the list of NSSAI is associated with at least one of a positioning mode, a sensing mode, a positioning-specific service type, or a sensing-specific service type; and communicating with the network entity based on at least one of the positioning mode, the sensing mode, the positioning-specific service type, or the sensing-specific service type.

Aspect 2 is the method of aspect 1, where the NSSAI includes at least one of: high-accuracy NSSAI, low-latency NSSAI, low-power NSSAI, SL positioning NSSAI, hybrid Uu-SL positioning NSSAI, or ML-enabled positioning NSSAI.

Aspect 3 is the method of aspect 1 or 2, where each NSSAI in the list of NSSAI includes at least one SST value or at least one SD value, and where different SST values or different SD values correspond to different positioning modes or services, or to different sensing modes or services.

Aspect 4 is the method of any of aspects 1 to 3, further including: receiving, from the network entity prior to the communication with the network entity, a second indication of at least one of the positioning mode, the sensing mode, the positioning-specific service type, or the sensing-specific service type.

Aspect 5 is the method of aspect 4, where the network entity corresponds to an LMF, and where transmitting the first indication of the list of NSSAI includes: transmitting the first indication directly to the LMF, or transmitting the first indication to the LMF via an AMF.

Aspect 6 is the method of aspect 5, where receiving the second indication includes: receiving the second indication directly from the LMF, or receiving the second indication from the LMF via the AMF.

Aspect 7 is the method of any of aspects 1 to 6, further including: transmitting, during an RRC inactive mode or an RRC idle mode via an RRC connection request message or an RRC resume request message, a second indication that indicates a suitable or desired NSSAI based on the list of NSSAI to initiate a positioning session.

Aspect 8 is the method of any of aspects 1 to 7, where the first indication is transmitted during an RRC connected mode via a positioning session request message.

Aspect 9 is the method of any of aspects 1 to 8, where communicating with the network entity based on at least one of the positioning mode, the sensing mode, the positioning-specific service type, or the sensing-specific service type includes: communicating with the network entity based on NSSAI not in the list of NSSAI.

Aspect 10 is the method of any of aspects 1 to 9, further including: receiving, from the network entity via assistance data, a list of suitable or desired NSSAI; and selecting the list of NSSAI based on the list of suitable or desired NSSAI.

Aspect 11 is the method of aspect 10, where the list of suitable or desired NSSAI is received during an RRC inactive mode or an RRC idle mode.

Aspect 12 is the method of any of aspects 1 to 11, further including: performing a prioritization between the list of NSSAI and a second list of NSSAI, where the second list of NSSAI is associated with RRM.

Aspect 13 is an apparatus for wireless communication at a UE, including: a memory; and at least one processor coupled to the memory and, based at least in part on information stored in the memory, the at least one processor is configured to implement any of aspects 1 to 12.

Aspect 14 is the apparatus of aspect 13, further including at least one of a transceiver or an antenna coupled to the at least one processor.

Aspect 15 is an apparatus for wireless communication including means for implementing any of aspects 1 to 12.

Aspect 16 is a computer-readable medium (e.g., a non-transitory computer-readable medium) storing computer executable code, where the code when executed by a processor causes the processor to implement any of aspects 1 to 12.

Aspect 17 is a method of wireless communication at a network entity, including: receiving, from a UE, a first indication of a list of NSSAI, where each NSSAI in the list of NSSAI is associated with at least one of a positioning mode, a sensing mode, a positioning-specific service type, or a sensing-specific service type; and communicating with the UE based on at least one of the positioning mode, the sensing mode, the positioning-specific service type, or the sensing-specific service type.

Aspect 18 is the method of aspect 17, where the NSSAI includes at least one of: high-accuracy NSSAI, low-latency NSSAI, low-power NSSAI, SL positioning NSSAI, hybrid Uu-SL positioning NSSAI, or ML-enabled positioning NSSAI.

Aspect 19 is the method of aspect 17 or 18, where each NSSAI in the list of NSSAI includes at least one SST value or at least one SD value, and where different SST values or different SD values correspond to different positioning modes or services, or to different sensing modes or services.

Aspect 20 is the method of any of aspects 17 to 19, further including: transmitting, for the UE prior to the communication with the UE, a second indication of at least one of the positioning mode, the sensing mode, the positioning-specific service type, or the sensing-specific service type.

Aspect 21 is the method of aspect 20, where the network entity corresponds to an LMF, and where receiving the first indication of the list of NSSAI includes: receiving the first indication directly from the UE, or receiving the first indication from the UE via an AMF.

Aspect 22 is the method of aspect 21, where transmitting the second indication includes: transmitting the second indication directly to the UE, or transmitting the second indication to the UE via the AMF.

Aspect 23 is the method of any of aspects 17 to 22, further including: receiving, during an RRC inactive mode or an RRC idle mode of the UE via an RRC connection request message or an RRC resume request message, a second indication that indicates a suitable or desired NSSAI based on the list of NSSAI to initiate a positioning session.

Aspect 24 is the method of any of aspects 17 to 23, where the first indication is received during an RRC connected mode of the UE via a positioning session request message.

Aspect 25 is the method of any of aspects 17 to 24, where the network entity corresponds to an LMF, the method further including: transmitting a list of suitable or desired NSSAI to a RAN that is associated with the UE.

Aspect 26 is the method of aspect 25, where the list of suitable or desired NSSAI is selected from the list of NSSAI, or is selected from outside the list of NSSAI.

Aspect 27 is the method of any of aspects 17 to 26, further including: transmitting, for the UE via assistance data, a list of suitable or desired NSSAI; and receiving the first indication of the list of NSSAI based on the list of suitable or desired NSSAI.

Aspect 28 is the method of aspect 27, where the list of suitable or desired NSSAI is transmitted during an RRC inactive mode or an RRC idle mode of the UE.

Aspect 29 is an apparatus for wireless communication at a network entity, including: a memory; and at least one processor coupled to the memory and, based at least in part on information stored in the memory, the at least one processor is configured to implement any of aspects 17 to 28.

Aspect 30 is the apparatus of aspect 29, further including at least one of a transceiver or an antenna coupled to the at least one processor.

Aspect 31 is an apparatus for wireless communication including means for implementing any of aspects 17 to 28.

Aspect 32 is a computer-readable medium (e.g., a non-transitory computer-readable medium) storing computer executable code, where the code when executed by a processor causes the processor to implement any of aspects 17 to 28.

1. An apparatus for wireless communication at a user equipment (UE), comprising:
a memory; and
at least one processor coupled to the memory, and the at least one processor is configured to:
transmit, for a network entity, a first indication of a list of network slice selection assistance information (NSSAI), wherein each NSSAI in the list of NSSAI is associated with at least one of a positioning mode, a sensing mode, a positioning-specific service type, or a sensing-specific service type; and communicate with the network entity based on at least one of the positioning mode, the sensing mode, the positioning-specific service type, or the sensing-specific service type.

2. The apparatus of claim 1, wherein the NSSAI comprises at least one of:
high-accuracy NSSAI, low-latency NSSAI, low-power NSSAI, sidelink (SL) positioning NSSAI, hybrid UE-UTRAN (Uu)-SL positioning NSSAI, or machine learning (ML)-enabled positioning NSSAI.

3. The apparatus of claim 1, wherein each NSSAI in the list of NSSAI includes at least one slice/service type (SST) value or at least one slice differentiator (SD) value, and wherein different SST values or different SD values correspond to different positioning modes or services, or to different sensing modes or services.

4. The apparatus of claim 1, wherein the at least one processor is further configured to:
receive, from the network entity prior to the communication with the network entity, a second indication of at least one of the positioning mode, the sensing mode, the positioning-specific service type, or the sensing-specific service type.

5. The apparatus of claim 4, wherein the network entity corresponds to a location management function (LMF), and wherein to transmit the first indication of the list of NSSAI, the at least one processor is configured to:
transmit the first indication directly to the LMF, or
transmit the first indication to the LMF via an access and mobility management function (AMF).

6. The apparatus of claim 5, wherein to receive the second indication, the at least one processor is configured to:
receive the second indication directly from the LMF, or
receive the second indication from the LMF via the AMF.

7. The apparatus of claim 1, wherein the at least one processor is further configured to:
transmit, during a radio resource control (RRC) inactive mode or an RRC idle mode via an RRC connection request message or an RRC resume request message, a second indication that indicates a suitable NSSAI based on the list of NSSAI to initiate a positioning session.

8. The apparatus of claim 1, wherein the at least one processor is configured to transmit the first indication during a radio resource control (RRC) connected mode via a positioning session request message.

9. The apparatus of claim 1, wherein to communicate with the network entity based on at least one of the positioning mode, the sensing mode, the positioning-specific service type, or the sensing-specific service type, the at least one processor is configured to:
communicate with the network entity based on NSSAI not in the list of NSSAI.

10. The apparatus of claim 1, wherein the at least one processor is further configured to:
receive, from the network entity via assistance data (AD), a list of suitable NSSAI; and select the list of NSSAI based on the list of suitable NSSAI.

11. The apparatus of claim 10, wherein the at least one processor is configured to receive the list of suitable NSSAI during a radio resource control (RRC) inactive mode or an RRC idle mode.

12. The apparatus of claim 1, wherein the at least one processor is further configured to:
perform a prioritization between the list of NSSAI and a second list of NSSAI, wherein the second list of NSSAI is associated with radio resource management (RRM).

13. A method of wireless communication at a user equipment (UE), comprising:
transmitting, for a network entity, a first indication of a list of network slice selection assistance information (NSSAI), wherein each NSSAI in the list of NSSAI is associated with at least one of a positioning mode, a sensing mode, a positioning-specific service type, or a sensing-specific service type; and
communicating with the network entity based on at least one of the positioning mode, the sensing mode, the positioning-specific service type, or the sensing-specific service type.

14. The method of claim 13, wherein the NSSAI comprises at least one of:
high-accuracy NSSAI, low-latency NSSAI, low-power NSSAI, sidelink (SL) positioning NSSAI, hybrid UE-UTRAN (Uu)-SL positioning NSSAI, or machine learning (ML)-enabled positioning NSSAI.

15. The method of claim 13, further comprising:
receiving, from the network entity prior to the communication with the network entity, a second indication of at least one of the positioning mode, the sensing mode, the positioning-specific service type, or the sensing-specific service type.

16. An apparatus for wireless communication at a network entity, comprising:
a memory; and
at least one processor coupled to the memory, and the at least one processor is configured to:
receive, from a user equipment (UE), a first indication of a list of network slice selection assistance information (NSSAI), wherein each NSSAI in the list of NSSAI is associated with at least one of a positioning mode, a sensing mode, a positioning-specific service type, or a sensing-specific service type; and
communicate with the UE based on at least one of the positioning mode, the sensing mode, the positioning-specific service type, or the sensing-specific service type.

17. The apparatus of claim 16, wherein the NSSAI comprises at least one of:
high-accuracy NSSAI, low-latency NSSAI, low-power NSSAI, sidelink (SL) positioning NSSAI, hybrid UE-UTRAN (Uu)-SL positioning NSSAI, or machine learning (ML)-enabled positioning NSSAI.

18. The apparatus of claim 16, wherein each NSSAI in the list of NSSAI includes at least one slice/service type (SST) value or at least one slice differentiator (SD) value, and wherein different SST values or different SD values correspond to different positioning modes or services, or to different sensing modes or services.

19. The apparatus of claim 16, wherein the at least one processor is further configured to:
transmit, for the UE prior to the communication with the UE, a second indication of at least one of the positioning mode, the sensing mode, the positioning-specific service type, or the sensing-specific service type.

20. The apparatus of claim 19, wherein the network entity corresponds to a location management function (LMF), and to receive the first indication of the list of NSSAI, the at least one processor is configured to:
receive the first indication directly from the UE, or
receive the first indication from the UE via an access and mobility management function (AMF).

21-30. (canceled)
